(19) United States
(12) Patent Application Publication
(10) Pub. No.: US 2025/0027853 A1
(43) Pub. Date: Jan. 23, 2025

(54) Transparent Embedding Solvent System and Use Thereof

(71) Applicant: CHINESE INSTITUTE FOR BRAIN RESEARCH, BEIJING, Beijing (CN)

(72) Inventors: Hu Zhao, Beijing (CN); Woo-Ping Ge, Beijing (CN); Yating Yi, Beijing (CN)

(21) Appl. No.: 18/709,426

(22) PCT Filed: Nov. 2, 2022
(86) PCT No.: PCT/CN2022/129331

§ 371 Date: May 10, 2024

(30) Foreign Application Priority Data
Nov. 11, 2021 (CN) 2021/130169

(51) Int. Cl. G01N 1/30; G01N 1/36; G02B 21/36

(52) U.S. Cl. CPC G01N 1/30; G01N 1/36; G02B 21/362

(57) ABSTRACT

Provided are a reagent for clearing tissue or organ, a reagent for dehydration of tissue or organ, a transparent embedding solvent system (TESOS) for transparent embedding tissue or organ, a method for clearing tissue or organ, a method for transparent embedding tissue or organ using the TESOS, and a method for microscopic imaging.

### INTRODUCTION

Tissue clearing has been a major technical breakthrough for microscopic imaging. By treating biological samples with various chemicals, tissue could be turned into transparent. Current clearing methods can be largely divided into three major categories including aqueous methods, solvent based methods and hydrogel-based methods (Tainaka et al., 2016). Most tissue clearing methods followed similar chemical principles and were comprised of steps including fixation, decalcification (for hard tissue), decolorization, delipidation, dehydration (for solvent based clearing methods only) and RI matching (Tainaka et al., 2016). Tissue clearing technique provides a powerful approach for optical imaging deep within biological specimens. Tissue clearing has also been employed to investigate peripheral nerves travelling long range within mouse body (Cai et al., 2019). In combination with nanobody staining and light sheet microscope, single axon resolution was achieved in some regions including the skin and the muscles surfaces (Cai et al., 2019).

Achieving isotropic high resolution throughout the entire sample is the major challenge for all current tissue-clearing based imaging. Even in cleared organs, when the optical path is long, aberration still will build up due to accumulated refractive index (RI) mismatch alone the long optical path and lead to resolution deterioration (Ueda et al., 2020). For example, optical aberration in peripheral organs and tissue is even more severe than in the brain due to various tissue components. Another technical barrier is the microscope objective. Image resolution is physically determined by the numeric aperture (NA) number of the objective. A high NA objective always has a very short working distance, which limits the image depth of the objective within the tissue (Chen et al., 2020; Gao, 2015).

Mammalian neurons give rise to extensive axons which may travel a very long distance to convey information across different areas. Mapping neural connectivity at a single axon level is crucial for understanding the neuron properties and the routing of information flow. Sensory neurons are the central components of somatosensory system. Somas of sensory neurons reside in the dorsal root ganglion (DRG) and trigeminal ganglia. They extend one axonal branch to the skin and connect with sensory endings to perceive external stimuli (Zimmerman et al., 2014) and another axonal branch to the spinal cord or the brainstem to convey the information to the central nervous system (Abraira and Ginty, 2013).

Most neural connectome research has been focused on brain. Various strategies have been designed to image and map axon connectivity in brain at single axon level (Economo et al., 2016; Gong et al., 2016; Li et al., 2010; Zeng, 2018; Zheng et al., 2013). Connection and projection mapping of peripheral nervous system were much less studied. Connectivity mapping of single sensory neurons in peripheral organs or spinal cord at high resolution has never been achieved in rodent model (Kuehn et al., 2019). Unlike brain, sensory axons travel a very long distance across complex tissue types including skin, muscle, fat and even bone etc., which made the high-resolution imaging or tracing very difficult. Thick histological sections or flat-mounted sample remained to be the only available approaches for investigating the peripheral or central projections of sensory neurons, which provided limited spatial information (Browne et al., 2020; Kuehn et al., 2019; Olson et al., 2016; Woodbury et al., 2001).

To achieve optical imaging deep within biological specimens tissue, and connectivity mapping of single sensory neurons in peripheral organs or spinal cord at high resolution has an urgent need for research and disease diagnosis purposes.

### SUMMARY OF THE INVENTION

The present invention relates to a reagent for clearing tissue or organ, a reagent for dehydration of tissue or organ, a transparent embedding solvent system (TESOS) for transparent embedding tissue or organ, a method for clearing tissue or organ, a method for transparent embedding tissue or organ using the TESOS, and a method for microscopic imaging.

In the first place, the present invention relates to a reagent for clearing tissue or organ, comprising organic solvent and monomer crosslinker for forming organogel.

The organic solvent is used as the solvent disperse phase, and the monomer crosslinker is capable of being crosslinked to form polymer, and the organic solvent phase is dispersed within the cross-linked polymer to form organogel.

The organogel not only was transparent by itself, but also maintained the tissues within equally transparent as in the solution.

In some embodiments, the organic solvent is benzyl benzoate.

In some embodiments, the monomer crosslinker may be selected from polyethylene glycol dimethacrylate; polyethylene glycol diacrylate; diethylglycol diacrylate; diethylene glycol dimethacrylate; ethyleneglycol diacrylate; ethylene glycol dimethacrylate; bisphenol-A ethoxylate dimethacrylate; bisphenol-A ethoxylate diacrylate; bisphenol-A glycidyl methacrylate; bisphenol-A glycidyl acrylate.

Preferably, the monomer crosslinker is polyethylene glycol diacrylate or bisphenol-A ethoxylate diacrylate. More preferably, the monomer crosslinker is bisphenol-A ethoxylate diacrylate.

In some embodiments, the reagent for clearing tissue or organ comprises benzyl benzoate (BB) and bisphenol-A ethoxylate diacrylate (BED).

Preferably, the bisphenol-A ethoxylate diacrylate is bisphenol-A ethoxylate diacrylate having Mn of 468 (BED468) or 512 (BED512).

Preferably, the reagent for clearing tissue or organ comprises 40-55% (v/v) benzyl benzoate (BB) and 40-55%% (v/v) of bisphenol-A ethoxylate diacrylate Mn 468 (BED468) or 512 (BED512).

In some embodiments, the reagent for clearing tissue or organ further comprises N,N,N′,N′-Tetrakis(2-Hydroxypropyl)ethylenediamine (Quadrol).

Preferably, the reagent for clearing tissue or organ comprises 2-7% (v/v) Quadrol, preferably, 5% (v/v) Quadrol.

In some embodiments, 2-hydroxy-4′-(2-hydroxyethoxy)-2-methylpropiophenone as UV initiator is further added to the reagent for clearing tissue or organ.

Preferably, the reagent for clearing tissue or organ comprises 1-3% (w/v) 2-Hydroxy-4′-(2-hydroxyethoxy)-2-methylpropiophenone, preferably, 2% (w/v) 2-Hydroxy-4′-(2-hydroxyethoxy)-2-methylpropiophenone.

In some embodiments, the reagent for clearing tissue or organ comprises 47% (v/v) benzyl benzoate (BB), 48% (v/v) of bisphenol-A ethoxylate diacrylate Mn 468 (BED468) or 512(BED512), 5% (v/v) Quadrol, and 2% w/v of 2-Hydroxy-4′-(2-hydroxyethoxy)-2-methylpropiophenone.

The tissue or organ is any of tissue or organ of the animal, including but not limited to skin, hairy, muscle, bone, nerve, brain, paw, spinal cord, vertebrae, mouse paw with skin, vertebrae with bone and muscles, spleen, liver, heart, eyeball, complete head of adult mouse, or even whole body of mouse pup.

In the second place, the present invention relates to a reagent for dehydration of tissue or organ comprising tert-butanol (tB) and N,N,N′,N′-Tetrakis(2-Hydroxypropyl) ethylenediamine (Quadrol).

In the present invention, the reagent is named as tB-Quadrol reagent.

In some embodiments, the reagent for dehydration of tissue or organ, comprises 60-80% (v/v) tB and 20-40% Quadrol (v/v).

Preferably, the reagent for dehydration of tissue or organ comprises 70% (v/v) tB and 30% (v/v) Quadrol.

In some embodiments, the dehydrated tissue or organ may be used for microscopic imaging.

The tissue or organ is any of tissue or organ of the animal, including but not limited to skin, hairy, muscle, bone, nerve, brain, paw, spinal cord, vertebrae, mouse paw with skin, vertebrae with bone and muscles, spleen, liver, heart, eyeball, complete head of adult mouse, or even whole body of mouse pup.

In the third place, the present invention relates to a transparent embedding solvent system (TESOS) comprising the reagent for clearing tissue or organ in the first place.

The organic solvent is used as the solvent disperse phase, and the monomer crosslinker is capable of being crosslinked to form polymer, and the organic solvent phase is dispersed within the cross-linked polymer to form organogel.

The organogel not only was transparent by itself, but also maintained the tissues within equally transparent as in the solution.

In some embodiments, the organic solvent is benzyl benzoate.

In some embodiments, the monomer crosslinker may be selected from polyethylene glycol dimethacrylate; polyethylene glycol diacrylate; diethylglycol diacrylate; diethylene glycol dimethacrylate; ethyleneglycol diacrylate; ethylene glycol dimethacrylate; bisphenol-A ethoxylate dimethacrylate; bisphenol-A ethoxylate diacrylate; bisphenol-A glycidyl methacrylate; bisphenol-A glycidyl acrylate.

Preferably, the monomer crosslinker is polyethylene glycol diacrylate or bisphenol-A ethoxylate diacrylate. More preferably, the monomer crosslinker is bisphenol-A ethoxylate diacrylate.

In some embodiments, the reagent for clearing tissue or organ comprises benzyl benzoate (BB) and bisphenol-A ethoxylate diacrylate (BED).

Preferably, the bisphenol-A ethoxylate diacrylate is bisphenol-A ethoxylate diacrylate having Mn of 468 (BED468) or 512 (BED512).

Preferably, the reagent for clearing tissue or organ comprises 40-55% (v/v) benzyl benzoate (BB) and 40-55%% (v/v) of bisphenol-A ethoxylate diacrylate Mn 468 (BED468) or 512 (BED512).

In some embodiments, the reagent for clearing tissue or organ further comprises N,N,N′,N′-Tetrakis(2-Hydroxypropyl)ethylenediamine (Quadrol).

Preferably, the reagent for clearing tissue or organ comprises 2-7% (v/v) Quadrol, preferably, 5% (v/v) Quadrol.

In some embodiments, 2-hydroxy-4′-(2-hydroxyethoxy)-2-methylpropiophenone as UV initiator is further added to the reagent for clearing tissue or organ.

Preferably, the reagent for clearing tissue or organ comprises 1-3% (w/v) 2-Hydroxy-4′-(2-hydroxyethoxy)-2-methylpropiophenone, preferably, 2% (w/v) 2-Hydroxy-4′-(2-hydroxyethoxy)-2-methylpropiophenone.

In some embodiments, the reagent for clearing tissue or organ comprises 47% (v/v) benzyl benzoate (BB), 48% (v/v) of bisphenol-A ethoxylate diacrylate Mn 468 (BED468) or 512 (BED512), 5% (v/v) Quadrol, and 2% w/v of 2-Hydroxy-4′-(2-hydroxyethoxy)-2-methylpropiophenone.

In some embodiments, the transparent embedding solvent system further comprises the reagent for dehydration of tissue or organ in the second place.

The reagent for dehydration of tissue or organ comprises tert-butanol (tB) and N,N,N′,N′-Tetrakis(2-Hydroxypropyl)ethylenediamine (Quadrol).

In the present invention, the reagent is named as tB-Quadrol reagent.

In some embodiments, the reagent for dehydration of tissue or organ, comprises 60-80% (v/v) tB and 20-40% Quadrol (v/v).

Preferably, the reagent for dehydration of tissue or organ comprises 70% (v/v) tB and 30% (v/v) Quadrol.

In some embodiments, the transparent embedding solvent system further comprises a reagent for fixation.

Preferably, the transparent embedding solvent system comprises 4% PFA by weight in water as the reagent for fixation.

In some embodiments, the transparent embedding solvent system further comprises a reagent for decolorization.

Preferably, the transparent embedding solvent system comprises 25% N,N,N′,N′-Tetrakis(2-Hydroxypropyl)ethylenediamine (Quadrol) solution was used as the decolorizing reagent to remove heme.

Preferably, Quadrol was diluted with H₂O to a final concentration of 25% (w/v). More preferably, Quadrol medium can be warmed in a 45° C. water bath to increase flowability.

In some embodiments, the transparent embedding solvent system further comprises a reagent for delipidation.

Preferably, the transparent embedding solvent system comprises gradient tert-butanol (tB) solution for delipidation.

Preferably, tert-Butanol (tB) was diluted with water to prepare gradient delipidation solutions: 30% (v/v), 50% (v/v) and 70% (v/v). Quadrol was added with 5% (w/v) final concentration to adjust the solution pH over 9.5.

In some embodiments, the transparent embedding solvent system further comprises a reagent for decalcification.

Before transparent embedding, cleared samples could be preserved in the clearing medium at room temperature in the dark for months.

In some embodiments, the transparent embedding solvent system comprises the reagent for fixation, the reagent for dehydration, and the reagent for clearing.

In some embodiments, the transparent embedding solvent system comprises the reagent for fixation, the reagent for decolorization, the reagent for dehydration, and the reagent for clearing.

In some embodiments, the transparent embedding solvent system comprises the reagent for fixation, the reagent for decolorization, the reagent for delipidation, the reagent for dehydration, and the reagent for clearing.

In some embodiments, the transparent embedding solvent system comprises the reagent for fixation, the reagent for decalcification, the reagent for decolorization, the reagent for delipidation, the reagent for dehydration, and the reagent for clearing.

The reagents within the transparent embedding solvent system may be contained in separated containers, and may be chosen according to the tissue or organ to be treated.

The reagents within the transparent embedding solvent system may be used sequentially.

The tissue or organ is any of tissue or organ of the animal, including but not limited to skin, hairy, muscle, bone, nerve, brain, paw, spinal cord, vertebrae, mouse paw with skin, vertebrae with bone and muscles, spleen, liver, heart, eyeball, complete head of adult mouse, or even whole body of mouse pup.

In the fourth place, the present invention relates to a method for clearing tissue or organ comprising a step of clearing tissue or organ using the reagent for clearing tissue or organ in the first place.

The tissue or organ is any of tissue or organ of the animal, including but not limited to skin, hairy, muscle, bone, nerve, brain, paw, spinal cord, vertebrae, mouse paw with skin, vertebrae with bone and muscles, spleen, liver, heart, eyeball, complete head of adult mouse, or even whole body of mouse pup.

In the fifth place, the present invention relates to a method for transparent embedding using the transparent embedding solvent system (TESOS) in the third place.

In some embodiments, the method for transparent embedding tissue or organ comprises a step of clearing tissue or organ using the reagent for clearing tissue or organ in the first place, or a step of transparent embedding using the transparent embedding solvent system (TESOS) in the third place so as to form transparent organogel.

The cleared tissue or organ within the transparent organogel, which is formed through polymerizing the monomer crosslinker and dispersing the organic solvent within the cross-linked polymer, so as to generate transparent organogel embedded with transparent tissue or organ.

Preferably, the step of transparent embedding comprises UV-initiated polymerization of the monomer crosslinker for UV curing. The container containing the sample may be placed under a high-power UV curing light.

The typical power readout for curing a cleared mouse brain is 40-60 mW/cm², preferably, 50 mW/cm², the lamp head is 7-9 cm, preferably 8 cm, from the samples. Curing time is generally 4-6 minutes, preferably, 5 minutes. Such set up could achieve full polymerization without causing sample overheating (below 55° C.), which could quench endogenous fluorescence signals.

Alternatively, inexpensive industrial UV light source purchased from eBay could also be used. The power setup and curing time need to be optimized to achieve polymerization without overheating. The temperature should be maintained to preserve endogenous fluorescence. For example, the temperature should not be over 55° C.

In general, at least 2-6 mm, preferably, 3-5 mm, gel surrounding the sample is preserved to provide sufficient support during cutting. Preferably, polymerized organogel has slightly higher RI than the solvent solution.

Polymerized sample remains transparent as in the solvent solution. The sample transparency could reduce significantly 10 days after curing, possibly due to ongoing polymerization within the tissue. Therefore, the embedded sample is preserved at 4° C. in the dark and imaged as soon as possible.

In some embodiments, the method for transparent embedding tissue or organ further comprises a step of dehydration using the reagent for dehydration in the second place.

In some embodiments, the method for transparent embedding tissue or organ further comprises a step of fixation using the reagent for fixation.

Preferably, the reagent for fixation comprises 4% PFA by eight, which is 4% paraformaldehyde by weight in 0.01M PBS.

As for trans-cardiac perfusion, 50 ml 4% PFA by weight (4% paraformaldehyde by weight in 0.01M PBS, pH 7.4) is injected transcardially for fixation. Preferably, before fixation, Ice-cold heparin PBS of 50-100 ml (10 U/ml heparin sodium in 0.01M PBS) was injected transcardially to flush the blood.

Preferably, for immersion of individual organs, the organs were immersed in 4% PFA by weight at room temperature for 24 hours before clearing. For the whole-body tissue clearing procedure, brain, tongue and all internal organs were removed. The eyeball and skin were preserved.

In some embodiments, the method for transparent embedding tissue or organ further comprises a step of decolorization using the reagent for decolorization.

Preferably, the reagent for decolorization comprises 25% N,N,N′,N′-Tetrakis(2-Hydroxypropyl)ethylenediamine (Quadrol) solution.

In some embodiments, the method for transparent embedding tissue or organ further comprises a step of delipidation using the reagent for delipidation.

Preferably, the reagent for delipidation comprises gradient tert-butanol (tB) solution.

In some embodiments, the method for transparent embedding tissue or organ further comprises a step of decalcification using the reagent for decalcification.

For organ containing hard tissue, decalcification treatment with EDTA solution was included before decolorization step.

For organ containing hard tissue, decalcification treatment with EDTA solution is included before decolorization step. Preferably, the decalcification solution is composed of 20% (w/v) Ethylenediaminetetraacetic acid (EDTA) in water. Sodium hydroxide may be used for adjusting the pH to 8.0.

For example, for a sample containing hard tissue, 4% PFA by weight fixation is performed at room temperature for 24 hrs and then the sample is decalcified in 20% EDTA (pH 7.0) at 37° C. temperature on a shaker for 4 days. The sample is then washed with distilled water for at least 30 mins to remove excessive EDTA. The sample is next decolorized with the Quadrol decolorization solution for two days at 37° C. on a shaker. The sample is then placed in gradient tB delipidation solutions for 1-2 days and then tB-Q for 2 days for dehydration. Finally, the sample is immersed in the BB-BED medium in a 37° C. shaker for at least one day until transparency is achieved.

For a soft tissue or organ, decalcification treatment is skipped. After 24 hours fixation, the sample is treated with Quadrol decolorization solution for 2 day at 37° C. The sample is next treated with gradient delipidation solutions in a 37° C. shaker for 1 to 2 days, followed by TBQ dehydration treatment for 1 to 2 days. Finally, the sample is placed in the BB-BED clearing medium in a 37° C. shaker for at least 1 day until final transparency being achieved.

Before transparent embedding, cleared samples could be preserved in the clearing medium at room temperature in the dark for months.

In some embodiments, the method for transparent embedding tissue or organ comprises the following steps: fixation, dehydration, clearing, and transparent embedding.

In some embodiments, the method for transparent embedding tissue or organ comprises the following steps: fixation, decolorization, dehydration, clearing, and transparent embedding.

In some embodiments, the method for transparent embedding tissue or organ comprises the following steps: fixation, decolorization, delipidation, dehydration, clearing, and transparent embedding.

In some embodiments, the method for transparent embedding tissue or organ comprises the following steps: fixation, decalcification, decolorization, delipidation, dehydration, clearing, and transparent embedding.

The reagent for fixation, the reagent for decalcification, the reagent for decolorization, the reagent for delipidation, the reagent for dehydration, and the reagent for clearing are defined in the third place.

The steps of fixation, decalcification, decolorization, delipidation, dehydration, and clearing and the sequences of the steps may be chosen according to the tissue or organ to be treated.

The BB-BED organogel not only was transparent by itself, but also maintained the tissues within equally transparent as in the solution.

In the sixth place, the present invention relates to a method for microscopic imaging comprising transparently embedding in the fifth place.

In some embodiments, the method for microscopic imaging further comprises a step of microscopic imaging using a microscope.

In some embodiments, the method for microscopic imaging further comprises a step of sectioning the transparently embedded sample.

The transparently embedded sample is organogel embedded with transparent sample. Therefore, the organogel not only was transparent by itself, but also maintained the tissues within equally transparent.

Preferably, the BB-BED organogel not only was transparent by itself, but also maintained the tissue within equally transparent as in the solution.

In some embodiments, the biological sample is any tissue or organ of the animal, including but not limited to skin, hairy, muscle, bone, nerve, brain, paw, spinal cord, vertebrae, mouse paw with skin, vertebrae with bone and muscles, spleen, liver, heart, eyeball, complete head of adult mouse, or even whole body of mouse pup.

In some embodiments, the biological sample is the sample of any size, which may be micropscopic imagined at high resolution with a block-face imaging strategy.

In some embodiments, the microscope is a confocal microscope, a two photon microscope, or a light sheet microscope.

Preferably, the transparently embedded sample is glued onto the top plate of the kinematic base.

Magnetic kinematic base is used for mounting the sample. The kinematic base is designed for re-mounting optical components with high repeatability and high precision. For example, the SB1(/M) round kinematic base comprises a top plate and a bottom plate. The top plate can be removed and replaced with an ON/OFF switch bar which interrupts the magnetic force coupling the plates of the base.

Preferably, the transparently embedded sample is glued onto the top plate of the kinematic base with two-component 5-min cure epoxy glue.

Preferably, the kinematic base bottom plate was secured under an upright confocal microscope, a two photon microscope, or a light sheet microscope.

Preferably, the bottom plate of the kinematic base is screwed onto a mounting base. The mounting base is tightly clamped onto the specimen clamp of any lab microtome.

Preferably, another bottom plate is secured with a screw onto a 2-axis goniometer stage. The goniometer stage is screwed onto the sample movement stage of the microscope.

In some embodiments, the sample is mounted under the microscope through the magnetic force. The top surface of the sample was imaged like a regular sample slide. The imaging depth is determined by the working distance of the objective.

In some embodiments, the sample is transferred between the microscope and a rotary microtome. After each sectioning, new Z stack was acquired with 10% overlapping with the previous stack. Magnetic base is the key element to ensure the samples being returned to identical positions after sectioning.

Preferably, alignment step is used to ensure that the sectioning plane is parallel to the imaging plane.

Preferably, alignment is performed prior to imaging a sample. An empty kinematic base top plate is locked onto the microtome bottom plate. The sectioning movement plane is adjusted by adjusting the block adjustment handles until it is parallel to the top plate surface.

In some embodiments, after the microtome alignment, the embedded sample is locked onto the microtome. Sectioning (for example, 5 μm/cut) is performed to expose a large area of sample surface. The sectioned sample is transferred onto the kinematic base on the microscope stage. The sample is examined with an objective, for example, a 10× objective. Endogenous fluorescence may not be required for this step if the tissue can be visualized based on autofluorescence. A large tile scan is performed by moving the X-Y stage. The goniometer stage is adjusted until the sample sectioning plane is parallel to the XY stage moving plane.

In the present invention, the alignment needs to be performed only once for a sample and will never be changed till the entire imaging process is completed.

The embedded sample is mounted on the microtome and sectioned (for example, 5 μm/cut) to expose the sample top surface. After sectioning, the surface is dropped with BB-BED medium and covered with a glass coverslip. The sample is next cured with a UV lamp for three to seven, for example, five seconds to polymerize the newly added medium and to secure the coverslip.

Preferably, oil immersion objective is used due to the high R.I. (1.55-1.56) of the BB-BED medium and gel. The imaging depth of each imaging Z-stack is determined by the objectives and imaging requirements. Preferably, the top plane of the Z stack should be at least 10 μm below the sample sectioning surface to avoid any potential distortion on the machined surface.

In some embodiments, after imaging the selected sample areas, the coverslip is removed by sliding it off the surface. The sample is transferred to the microtome for sectioning (for example, 5 μm/cut). The sectioning depth should be at least 10% less than the Z-stack depth to provide overlapping area for stacks stitching. Sectioned sample is repositioned onto the kinematic base on the microscopy stage and dropped with BB-BED medium followed by coverslip placement and UV curing for the next imaging cycle.

Such imaging-sectioning cycles are repeated until the region of interest (ROI) was completely imaged.

Alternatively, top surface of the sample could be removed with a high-speed bur on the milling motor. The milling motor was built next to the microscope stand. The milling motor is especially suitable for large sample, even very large sample.

The sample is moved along a linear guide between the motor and the microscope. The linear guide is the key element to ensure the sample being repositioned precisely after milling.

In some embodiments, a high precision linear guide is installed on the sample XY movement stage. One end of the linear guide is under the objective and the other end is under the milling platform. Under the objective, a kinematic magnetic base plate is connected with the sliding block on the linear guide through a vertical translational stage. The vertical stage is equipped with a fine-adjustment micrometer. The milling platform is installed on the left side of the confocal microscope and is composed of a water-cooled spindle motor installed on a vertical translational stage. The transparent embedded sample is glued onto the kinematic base top plate and locked onto the base plate under the objective. The sample is first moved along the linear guide to under the milling motor. The sample surface is milled off with an end-cutting milling bur, for example, a 2 mm end-cutting milling bur. The sample movement under the motor is controlled by the sample stage. The cutting depth is controlled by adjusting the vertical stage position with the micrometer. The debris is blown off and a drop of BB-BED medium is placed onto the milling surface and a coverslip is placed. After curing the newly added medium with a UV light, the sample is moved back to the objective along the linear guide. Mechanical stop is installed on the linear guide to ensure repeatable reposition. The top plane of the Z stack should be at least 25 μm below the milling surface due to the relatively higher roughness from the milling process.

No alignment is needed for the milling setup since the milling X-Y movement during the milling is controlled by the sample stage so that the milling surface is already in line with the imaging plane.

In some embodiments, as for the distorted sample surface, for example, the surface of brain, vertebrae, femur and complete head of adult mouse, overlaying of pre- and post-sectioning images indicated overall organization and very fine structures like neuron dendrites remain unchanged after sectioning.

According to the method for microscopic imaging of the present invention, X-Z and Y-Z optical slices indicate continuous structure in Z dimension.

According to the method for microscopic imaging of the present invention, sectioning does not distort cellular organization.

According to the method for microscopic imaging of the present invention, with the cervical vertebrae segment including both spinal cord and surrounding bones, dine neural structure is clearly visualized, including the DRG neuron soma, central axonal branch, axonal arbor and boutons. The image is continuous on Z dimension. Fine structure including arbor and axons remains intact and continuous in Z dimension.

The method for microscopic imaging of the present invention is applicable for organs of various tissue types and enabled sub-micron resolution imaging for large samples.

The method for microscopic imaging of the present invention is compatible with immunofluorescent staining. The immunofluorescent staining includes staining using an antibody against laminin and/or GFAP.

As for bone sample, the bone sample is fixed in 70% ethanol for two days at room temperature with a one-time change of 70% ethanol. The sample is then dehydrated in 95% ethanol for one day and 100% ethanol for one day. Next, the sample is immersed in 1% FITC (Sigma, cat. no. F7250) in 100% ethanol solution for 48 hrs. After staining, the sample is washed with PBS solution for 24 hrs and processed following TESOS method for hard tissues.

The whole-mount immunofluorescent staining is performed as previously described in the art.

The “integrated intensity” values may be measured using Image J (NIH). Average signal intensity of samples after fixation is defined as initial intensity and is normalized as 1.00. The ratio of “integrated intensity” value of other time points to initial intensity is calculated to evaluate the fluorescence intensity change.

In some embodiments, for tissues with strong autofluorescence including skin, skeletal muscles and bones etc. linear channel unmixing is performed to distinguish true fluorescent signal from tissue autofluorescence. Autofluorescence signal widely spreads from 350 nm to 600 nm, whereas fluorescence from protein or antibody conjugation is very restricted. Depending on the endogenous fluorescence spectrum, the autofluorescence detection channel may be setup at either 488 nm or 568 nm wavelength. The imaging parameters for autofluorescence detection channel are carefully adjusted so that little true fluorescence signal is detected.

In some embodiments, the channel unmixing operation is performed with the “image calculator” function in the Image J (NIH Image J). The autofluorescence signal is subtracted from the true signal channel to generate a new channel and the new channel is combined with the previous autofluorescence channel to generate the final images. Autofluorescence signal is used for outlining tissues.

In some embodiments, image deconvolution is accomplished with the “microvolution” module within the Slidebook 6.0 software (31 inc.). The iteration number is set as 10. Regularization is set as “none”. Blind deconvolution is checked. PSF model is automatically generated based on the optical parameter being provided.

In some embodiments, BigStitcher module within the Image J is used for stitching imaging tiles. 10% overlapping is set up for adjacent tiles. Image stacks are exported as image sequence of .tif format. Image stacks before and after samples sectioning/milling are sequentially stitched based on the overlapping regions. For two consecutive stacks, to facilitate speed, only image sequences in the overlapping zone are selected. Pairwise stitching module of the Image J is run to stitch these selected images together. The other image sequences in the two stacks are modified their metadata (custom Image J macro code).

In some embodiments, for 3-D rendering, image sequences are converted into .IMS format (Imaris Converter, Bitplane). 3-D rendering, snapshots and animation are performed with Imaris (Bitplane). Multiresolution pyramid is generated from stitched image sequences for 3-D tracing (TeraConverter, Bria et al. 2016). Manual tracing of axons is performed by a team of two annotators using TeraFly in Vaa3D (Peng et al., 2014; Peng et al., 2010). For registration, spinal cord image stacks are resliced for planes orthogonal to the rostrocaudal axis of the spinal cord. The resliced imaging plane is aligned and annotated based on the spatial map for the Allen Mouse Spinal Cord Atlases (the Allen Institute).

In some embodiments, to reduce the final data size for axon tracing, the stitched imaging data is separated into three parts: 1. nerve ending in paw; 2. nerve bundle in the arm; 3. DRG and projection within the spinal cord. An overlap of 40 slices is retained in each part for the determination of axon positions. For the first part, manual 3D tracing of axons is performed with TeraFly in Vaa3d. For the second part, tracing of single axon is performed manually using stitched 2D slices in Image J. Target axon from the first part is shown in “Section” mode in Vaa3D in order to display its localization in 2D slices, and to find its counterpart in the second part. Finally, axon tracing into the DRG and its projection within the spinal cord is done manually with Terafly in Vaa3D. Each tracing procedure is performed by a team of two annotators.

In some embodiments, N number is reported in figures and legends. Data are presented as mean±standard deviation using one-way ANOVA or Student's t tests. Statistical analysis was performed in GraphPad Prism and Microsoft Excel.

The TESOS method in combination with milling platform enabled the micron-scale resolution imaging of whole body composed of various tissue types.

The method for microscopic imaging of the present invention is capable of achieving reconstruction of sensory field of an individual sensory nerve axon. The nerve axons innervating the carpal vibrissae may be visualized. Nerve axons and endings are visualized. All endings derived from individual axon could be traced

The method for microscopic imaging of the present invention is capable of achieving reconstruction and mapping of complete projection of single DRG neurons within the spinal cord. All parts of the neuron were visualized, including DRG central axons, collateral branches, arbors and boutons. Lateral view of the image stack indicated that sectioning process did not disrupt the structural continuity. Reconstructed neuron soma and axon remained intact and continuous in z dimension. All fine details of single neurons could be identified. The spatial overlap between central projection arbors of adjacent collateral branches from the same neuron is visualized. Spatial overlap between projection arbors from two different DRG neurons is also visualized. The complete central projection arbors of DRG neurons is outlined.

The method for microscopic imaging of the present invention is capable of achieving reconstruction of long-range projection of sensory neurons from forepaw to spinal cord.

In the seventh place, the present invention relates to a method for mapping of projection of single neuron comprising a step of treating the biological sample using the reagent in the first place, or the reagent in the third place, a step of sectioning the transparently embedded sample, and a step of microscopic imaging using a microscope.

### BRIEF DESCRIPTION OF THE DRAWINGS

FIG. 1 shows technical pipeline of the TESOS method.

FIG. 2 shows that TESOS method enables transparent embedding of various tissue and organs without losing transparency and endogenous fluorescence

FIG. 3 shows microtome and milling platforms for sectioning or milling embedded samples.

FIG. 4 shows sub-micron resolution imaging of Thy1-EGFP brain sample.

FIG. 5 shows DRG sensory neurons and their projections in the spinal cord.

FIG. 6 shows high resolution imaging of the human bone sample stained with fluorescein isothiocyanate dye (FITC).

FIG. 7 shows high resolution imaging of samples stained with antibodies.

FIG. 8 shows whole body imaging at micron scale resolution.

FIG. 9 shows nerves within the forepaw of an adult Thy1-YFP16 mouse.

FIG. 10 shows tracing of sensory axons innervating Meissner Corpuscles under the five walking pads of adult Thy1-YFP16 mouse forepaw.

FIG. 11 shows complete projections of single sensory neurons in the spinal cord.

FIG. 12 shows complete projection of one sensory neuron within the spinal cord.

FIG. 13 shows complete projection mapping of twelve sensory neurons within the spinal cord.

FIG. 14 shows mapping of individual sensory neurons from the hair follicles on the forepaw to the spinal cord.

### DESCRIPTION OF PARTICULAR EMBODIMENTS OF THE INVENTION

Hydrogel was commonly used in many biomedical applications including tissue clearing techniques. Low concentration hydrogel polymerized from acrylamide and water protects proteins from harsh detergent treatment (Chung et al., 2013; Treweek et al., 2015; Yang et al., 2014). Organogel is a gel composed of an organic solvent phase dispersed within a cross-linked polymer and was used for drug delivery or cosmetic products (Skilling et al., 2014; Tan et al., 2020; Yuan et al., 2019).

TESOS method in the present invention is the first application of organogel in the microscopic imaging field. It was noticed by coincident benzyl benzoate solution may form transparent gel in the presence of polyethylene glycol diacrylate (PEG-DA), while the samples within still remained transparent. Following this clue, many combinations are tested and BB-BED formula is identified. In this formula, benzyl benzoate (BB) is the solvent disperse phase.

Bisphenol-A ethoxylate diacrylate (BED) is a dental monomer crosslinker known for its biosafety and strength (Fleisch et al., 2010; Xie et al., 2017). Both BB and BED have high RI (BB, 1.56; BED 1.55). The high RI helps to render both soft and hard tissues transparent. Quadrol keeps the medium basic pH to protect GFP fluorescence (Jing et al., 2018; Schwarz et al., 2015). 2-Hydroxy-4′-(2-hydroxyethoxy)-2-methylpropiophenone UV initiator was used to initiate the radical polymerization reactions. Comparing with heat-initiation, UV-initiation provides much better control over the reaction heat, which helps protect GFP activity.

Transparent embedding in the present invention is defined as the process of embedding samples without losing tissue transparency and endogenous fluorescence. In many formulas tested, samples lost their transparency after polymerization despite of excellent transparency in the solution form. A formula composed of BB and PEG-DA also achieved transparent embedding. However, its organogel was too soft to provide mechanical support.

Block face imaging methods, including Mouselight and fMOST, were designed to achieve axon level isotropic resolution within rodent brains (Economo et al., 2016; Li et al., 2010; Tao et al., 2012; Zheng et al., 2013). However, none of them was applicable for organs made of complex tissue types, mostly due to insufficient embedding support. For block face imaging, top surface of the sample was removed and then the block surface was imaged. To stitch image blocks before and after processing together, it is important that samples remained no distortion and reposition without tilting.

Organogel composed of BB and poly-BED is nearly two folds stronger than a paraffin wax used for histological embedding. A tissue sample composed of both soft and hard tissues embedded within could therefore resist sectioning/milling process without distortion. We designed two processing strategies for reducing sample surface. Sectioning strategy was based on regular rotary microtome. Embedded samples were repeatedly transferred between microtome and microscope. Magnetic kinematic base is the key component to ensure precise re-position. This strategy could be easily achieved with commercially available parts without major modification to the microscope. Although we only tested Leica and Zeiss microscope in this study, sectioning strategy can be adopted to any upright confocal/two photon microscopes. Milling motor strategy was designed for processing large samples. For larger samples, minor positioning errors may accumulate during processing and made stitching challenging. The industrial linear guide repositioned samples with much higher precision. Although both strategies were currently operated manually, they can both be automized in the future.

Strong autofluorescence from skin, muscles and bone was another major challenge for imaging peripheral organs of complexed tissues (Monici, 2005). Immunostaining with nanobody was used to boost the signal over autofluorescence (Cai et al., 2019). In our study, attributed to the excellent preservation of endogenous fluorescence, we were able to utilize linear channel unmixing method to subtract autofluorescence from the authenticate GFP signal without boosting antibodies (Chorvat et al., 2005; McRae et al., 2019). This strategy was applicable for strong reporter strains including Thy1-EGFP-M, Thy1-EYFP-H, Thy1-YFP16 and Ai140. Ai14, Ai57 and Ai65 were applicable for brain imaging, but not for peripheral organs due to their relative weak fluorescence intensity.

Organization of LTMRs under hairy and glabrous skins were previously studied using flat mount skin (Kuehn et al., 2019; Neubarth et al., 2020). TESOS method enables the sub-micron resolution imaging of an intact mouse paw and provided spatial organization information of sensory axons. Analysis results are similar with previously described (Neubarth et al., 2020).

Central organization and process of the information input from the sensory organs is a fundamental question for neuroscientist. In the direct DC pathway model, individual LTMR neurons convey information directly into brainstem DCN, where the information is relayed (Johnson, 2001; Mountcastle, 1957; Niu et al., 2013). More recently, an LTMR-RZ model was proposed. In this model, hairy skin LTMR synapse reside mainly within the spinal cord dorsal zone with few synapses in the DCN, indicating the spinal cord interneurons as the relay center for integrating somatosensory input (Abraira et al., 2017; Bai et al., 2015; Li et al., 2011).

It remained unknown if glabrous skin sensory neurons follow the same projection pattern. Our tracing results of 12 DRG neurons within the spinal cord provided direct evidence and suggests that sensory neurons for glabrous skin fit in the same model. All the DRG neuron somas labelled by AAV injected under the walking pad were localized in DRG C5, C6, C7 and C8. Their arbor projections are mostly between C4 and T1 segment. None of their axon or arbor extends beyond C1 into the brainstem.

Syn-Cre AAV injected in the walking pad has no selectivity for neurons types and may label both nociceptive and non-nociceptive neurons. For convenience, large neurons were chosen for our analysis. Although small DRG neurons were also visualized in the DRGs, few arbors were visualized beyond C4 in the rostral direction, suggesting that central projection of nociceptive neurons may also follow the same model. It appears that most sensation information from the forepaw walking pad was projected to a restricted spinal cord segment between C4 and T1, but not to the brainstem DCN.

Mesoscale brain connectome mapping is the frontier of neuroscience research, which provided critical information on organization principles of long-range neural connectivity (Peng et al., 2020; Winnubst et al., 2019). Mesoscale connectome mapping has never been achieved for the peripheral nervous system (PNS). Sensory neurons project their axons from peripheral organs to the spinal cord across various tissue types. Our study provided the first full course tracing of individual sensory neurons from digits to spinal cord in the entirety. Five sensory neurons innervating hairy skin LTMRs were reconstructed from the digits to the spinal cord spanning over 6 cm. Thy1-EGFP-M strain was chosen because of its strong GFP fluorescence and relative sparse neuron labelling comparing with Thy1-YFP-H or Thy1-YFP16. Although tracing results from five neurons were insufficient for extrapolating significant conclusions, the TESOS method will provide a powerful tool for PNS connectome mapping at mesoscale in the future.

The descriptions of particular embodiments and examples are provided by way of illustration and not by way of limitation. Those skilled in the art will readily recognize a variety of noncritical parameters that could be changed or modified to yield essentially similar results.

### EXAMPLES

### Methods

### Animals

Mice were purchased from the Jackson Lab with genotypes including C57BL/6 (JAX #000664), Thy1-EGFP (JAX #007788), Thy1-YFP-16(JAX #003709), Ai14 (JAX #007908), Ai 140 (JAX #030220) and Shh-Cre^{ERT2} (JAX #005623). Human femur bone samples were kindly provided by Dr. Jian Q. Feng of the Texas A&M University. All animal experiments were approved by the Institutional Animal Care and Use Committee the Texas A&M University and were in accordance with guidelines from the NIH/NIDCR.

For tamoxifen treatment, tamoxifen was dissolved in corn oil at 20 mg/ml. The solution was kept at −20° C. and delivered via intraperitoneal injection or oral gavage for postnatal treatments.

### Preparation of TESOS Solutions

### Decalcification Medium

Decalcification solution was composed of 20% (w/v) Ethylenediaminetetraacetic acid (EDTA) (Sigma-Aldrich E5134) in water. Sodium hydroxide (Sigma-Aldrich) was used for adjusting the pH to 8.0.

### Decolorization Medium

Quadrol medium (Sigma-Aldrich 122262) was diluted with H₂O to a final concentration of 25% (w/v). Due to the very vicious property of Quadrol, weighing is more convenient than measuring the volume. Quadrol medium can be warmed in a 45° C. water bath to increase flowability.

### Gradient tB Delipidation Medium

tert-Butanol (tB) (Sigma-Aldrich 360538) was diluted with water to prepare gradient delipidation solutions: 30% (v/v), 50% (v/v) and 70% (v/v). Quadrol (Sigma-Aldrich 122262) was added with 5% (w/v) final concentration to adjust the solution pH over 9.5.

tB-Q Dehydration Medium

Dehydrating medium was composed of 70% (v/v) tert-Butanol and 30% (w/v) Quadrol (Sigma-Aldrich 122262).

### BB-BED Clearing Medium (Refractive Index R.I. 1.552)

Unless indicated in the manuscript, the BB-BED clearing medium was composed of 47% (v/v) benzyl benzoate (BB) (Sigma-Aldrich W213802), 48% (v/v) of bisphenol-A ethoxylate diacrylate Mn 468 (BED468) (Sigma-Aldrich 413550), 5% (v/v) Quadrol (Sigma-Aldrich 122262) and then supplemented with 2% w/v of 2-Hydroxy-4′-(2-hydroxyethoxy)-2-methylpropiophenone (Sigma Aldrich 410896) as the UV initiator. Bisphenol-A ethoxylate diacrylate Mn 512 (BED512) (Sigma-Aldrich 412090) could also be used to replace BED 468 at the same ratio with similar mechanical properties. The BB-BED medium was a colorless liquid with low viscosity and could be preserved at room temperature in the dark.

### Perfusion and Tissue Preparation

For trans-cardiac perfusion, mice were anesthetized with an intraperitoneal injection of a combination of xylazine and ketamine anesthetics (Xylazine 10-12.5 mg/kg; Ketamine, 80-100 mg/kg body weight). Ice-cold heparin PBS of 50-100 ml (10 U/ml heparin sodium in 0.01M PBS) was injected transcardially to flush the blood. 50 ml 4% PFA by weight (4% paraformaldehyde in 0.01M PBS, pH 7.4) was then injected transcardially for fixation.

For the whole-body tissue clearing procedure, brain, tongue and all internal organs were removed. The eyeball and skin were preserved. For immersion of individual organs, the organs were immersed in 4% PFA by weight at room temperature for 24 hours before clearing.

### Fluorescein Isothiocyanate (FITC) Staining for Human Bone Samples

FITC staining was performed as previously described (Ren et al., 2014). The human specimen obtained from femur cortical bone was cut to cubic size with a diamond saw. The bone sample was fixed in 70% ethanol for two days at room temperature with a one-time change of 70% ethanol. The samples were then dehydrated in 95% ethanol for one day and 100% ethanol for one day. Next, the samples were immersed in 1% FITC (Sigma, cat. no. F7250) in 100% ethanol solution for 48 hrs. After staining, samples were washed with PBS solution for 24 hrs and processed following TESOS method for hard tissues.

### Skin Viral Labeling

Skin viral injection protocol was modified based on previous publication (Bloom et al., 2019; Kuehn et al., 2019). Ai140 (Jax 030220) reporter mice of P6 were used for viral injection. High titer (>10¹² GC/ml) AAV2/1-hSyn-Cre-WPREhGH virus (Addgene 105553-AAV1) was diluted 1:8 or 1:4 in 0.9% saline and 1 μl was injected under the forepaw skin. The virus was a gift from James M. Wilson (Addgene plasmid #105553; RRID:Addgene_105553). Mice were euthanized 2 months after injection.

### Whole-Mount Immunofluorescent Staining

The whole-mount immunofluorescent staining was performed as previously described (Jing et al., 2018). After 4% PFA by weight fixation, samples were decolorized with 25% Quadrol for 1 day and then washed with the PBS solution for 30 minutes. Samples were immersed in the blocking solution composed of 10% dimethyl sulfoxide (Sigma-Aldrich 276855), 1× casein buffer (Vector, SP-5020) and 0.5% IgePal630 (Sigma-Aldrich 18896) for blocking overnight. After blocking, samples were stained with the primary antibody diluted with the blocking solution for at least 72 hours at 4° C. Following that, tissues were washed with PBS at room temperature for 24 hrs and then immersed in the secondary antibodies diluted with the blocking solution for another three days at 4° C. After secondary antibody staining, samples were washed with PBS for 6 hours and then moved to the delipidation and dehydration solutions following the TESOS clearing procedure.

Antibodies used for whole-mount staining included rabbit anti-GFAP antibody (1:100, Abcam ab7260), rabbit anti-Laminin antibody (dilution 1:50, Sigma-Aldrich L9393), goat anti-rabbit IgG Alexa Fluor 488 (dilution 1:200, Thermo Fisher A11034).

### Quantification of Fluorescence Intensity

Half brain slices of 0.5 mm thickness from adult Thy1-EGFP mice were used for quantification of fluorescence intensity change. Fluorescent images of each time point were taken with a Zeiss stereo fluorescence microscope (Zeiss AxioZoom.V16) with the same zoom factor and exposure time. The “integrated intensity” values were measured using Image J (NIH). Average signal intensity of samples after fixation was defined as initial intensity and was normalized as 1.00. The ratio of “integrated intensity” value of other time points to initial intensity was calculated to evaluate the fluorescence intensity change.

### Quantification of Relative Young's Modulus

For quantification of Young's modulus, a column with diameter of 3.5 mm and height of 10 mm was formed with 3% agarose, wax, and BB-BED solvent, respectively. Fixed brain and cleared brain were cut into the same shape for test. Young's modulus was measured with tabletop Uniaxial Testing Machine (TestResources, USA), with compression load at the speed of 0.02 mm/second. The average Young's modulus of fixed brain was normalized as 1.00, and the ratio of Young's modulus of other tissue or materials to that of fixed brain was calculated as the “relative Young's modulus”.

### TESOS Clearing Procedure

For samples containing hard tissues, 4% PFA fixation was performed at room temperature for 24 hrs and then samples were decalcified in 20% EDTA (pH 7.0) at 37° C. temperature on a shaker for 4 days. Samples were then washed with distilled water for at least 30 mins to remove excessive EDTA. Samples were next decolorized with the Quadrol decolorization solution for two days at 37° C. on a shaker. Samples were placed in gradient tB delipidation solutions for 1-2 days and then tB-Q for 2 days for dehydration. Finally, samples were immersed in the BB-BED medium in a 37° C. shaker for at least one day until transparency was achieved.

For soft tissues organs, decalcification treatment was skipped. After 24 hours fixation, samples were treated with Quadrol decolorization solution for 2 day at 37° C. Samples were next treated with gradient delipidation solutions in a 37° C. shaker for 1 to 2 days, followed by TBQ dehydration treatment for 1 to 2 days. Finally, samples were placed in the BB-BED clearing medium in a 37° C. shaker for at least 1 day until final transparency being achieved.

Before transparent embedding, cleared samples could be preserved in the clearing medium at room temperature in the dark for months.

The time schedule for clearing different types of tissue with immersion method is summarized in the following table.

TABLE 1
PEGASOS immersion method time schedule.

| | Soft tissue organs | | Hard tissue | | Large body trunk | |
|---|---|---|---|---|---|---|
| 20% EDTA | none | | 4 | days | 7 | days |
| 25% quadrol | 2 | days | 2 | days | 2 | days |
| 30% tert-butanol | 4 | hours | 4 | hours | 1 | day |
| 50% tert-butanol | 6 | hours | 6 | hours | 1 | day |
| 70% tert-butanol | 1 | days | 1 | days | 1 | day |
| tB-Q dehydration | 2 | days | 2 | days | 2-3 | days |
| BB-BED clearing | 1 | day | 1 | day | 2 | days |
| Total time | 6-7 | days | 10.5 | days | 16-19 | days |

### Transparent Embedding of Cleared Samples Through UV-Initiated Polymerization

The transparent embedding could be performed as early as 2 days after the sample transparency being achieved.

For small samples including mouse internal organs, regular plastic syringes were modified as the curing chamber. The adaptor and bottom of regular plastic syringes of 10 ml or 25 ml were removed. Samples were placed in the syringe barrel with 2-5 ml of BB-BED medium. Make sure the sample is away from the barre wall.

Syringe containing the samples was placed under a high-power UV curing light (Thorlabs CS20K2). The typical power readout for curing a cleared mouse brain is 50 mW/cm², the lamp head was 8 cm from the samples. Curing time is 5 minutes. Such set up could achieve full polymerization without causing sample overheating (below 55° C.), which could quench endogenous fluorescence signals.

Alternatively, inexpensive industrial UV light source purchased from eBay could also be used. The power setup and curing time need to be optimized to achieve polymerization without overheating. At any time, the temperature should not be over 55° C. to preserve endogenous fluorescence.

After UV curing, the samples were removed from the syringe by pushing the plunger. A scalpel was used to trim extra gel. Make sure to preserve at least 3-5 mm gel surrounding the sample to provide sufficient support during cutting. Embedded samples could be preserved in a 50 ml tubes. Polymerized organogel has slightly higher RI (1.560) than the solvent solution (1.552).

For transparent embedding of much larger samples including mouse pup whole body or adult mouse body trunks, customized glass chambers were used as the curing chamber. The UV curing was performed from all angles and the curing time was determined based on preliminary experiments. Typically, a mouse pup whole body could be polymerized within 30 minutes. After removing embedded samples from the chamber, the samples could be furtherly illuminated with the UV light from every angle to ensure complete polymerization. A complete polymerization could be indicated when fingers holding the gel felt no more heat being generated.

Polymerized samples remained transparent as in the solvent solution. The sample transparency could reduce significantly 10 days after curing, possibly due to ongoing polymerization within the tissue. Therefore, embedded samples are better preserved at 4° C. in the dark and imaged as soon as possible.

### Mounting and Alignment of Embedded Samples on a Rotary Microtome

Magnetic kinematic base (SB1/M, Thorlabs) was used for mounting samples. The kinematic base was designed for re-mounting optical components with high repeatability and high precision. The SB1(/M) round kinematic base is composed of a top plate and a bottom plate. The top plate can be removed and replaced with an ON/OFF switch bar which interrupts the magnetic force coupling the plates of the base.

Embedded samples were glued onto the top plate of the kinematic base (SB1/M, Thorlabs) with two-component 5-min cure epoxy glue (Gorilla, Home Depot). The bottom plate of the kinematic base was screwed onto a mounting base (Thorlabs BA1/M). The mounting base was tightly clamped onto the specimen clamp of any lab microtome (either Sakura ACCU-CUT SRM or Leica 2050 was used in our lab).

Another bottom plate was secured with a screw onto a 2-axis goniometer stage (Thorlabs GNL20/M). The goniometer stage was screwed onto the sample movement stage (Scientifica MMBP motorized XY stage in our lab) of the microscope (Leica Sp8 confocal). For other microscopy brands, we improvised customized design to connect the kinematic base bottom plate onto the sample stage.

The sample will be transferred between the kinematic base on the microtome or on the microscope stage. Alignment was performed prior to imaging a sample. An empty kinematic base top plate was locked onto the microtome bottom plate. The sectioning movement plane is adjusted by adjusting the block adjustment handles until it is parallel to the top plate surface.

After the microtome alignment, an embedded test sample was locked onto the microtome. Sectioning (5 μm/cut) was performed to expose a large area of sample surface. The sectioned sample was transferred onto the kinematic base on the microscope stage. The samples were examined with a 10× objective. Endogenous fluorescence is not required for this step since the tissue can be visualized based on autofluorescence. A large tile scan was performed by moving the X-Y stage. The goniometer stage was adjusted until the sample sectioning plane is parallel to the XY stage moving plane.

The alignment needs to be performed only once for a sample and should never be changed till the entire imaging process is completed.

### Imaging and Sectioning of the Transparently Embedded Samples.

Embedded samples were mounted on the microtome and sectioned (5 μm/cut) to expose the sample top surface. After sectioning, the surface was dropped with BB-BED medium and covered with a glass coverslip. Samples were next cured with a UV lamp (Thorlabs CS20K2) for five seconds to polymerize the newly added medium and to secure the coverslip.

The embedded samples could be imaged with an upright confocal/2-photon microscopy as a regular slide. For immersion objectives, immersion oil could be dropped directly onto the coverslip. Oil immersion objectives are highly recommended due to the high R.I. (1.55-1.56) of the BB-BED medium and gel. The imaging depth of each imaging Z-stack is determined by the objectives and imaging requirements. The top plane of the Z stack should be at least 10 μm below the sample sectioning surface to avoid any potential distortion on the machined surface.

After imaging the selected sample areas, the coverslip was removed by sliding it off the surface. The sample was transferred to the microtome for sectioning (5 μm/cut). The sectioning depth should be at least 10% less than the Z-stack depth to provide overlapping area for stacks stitching. Sectioned sample was repositioned onto the kinematic base on the microscopy stage and dropped with BB-BED medium followed by coverslip placement and UV curing for the next imaging cycle.

Such imaging-sectioning cycles were repeated until the region of interest (ROI) was completely imaged.

Milling of Transparently Embedded Samples with a Milling Motor Platform

Very large samples including mouse pup whole body and adult mouse body trunk were processed with a milling motor setup built on an upright Leica Sp8 confocal microscope. A high precision linear guide (IKO LWLF 42B) was installed on the sample XY movement stage (Scientifica Inc. MMBP). One end of the linear guide was under the objective and the other end was under the milling platform. Under the objective, a kinematic magnetic base plate (SB1/M, Thorlabs) was connected with the sliding block (IKO LWLFF 42BCS) on the linear guide through a vertical translational stage (Thorlabs MVS 005). The vertical stage was equipped with a fine-adjustment micrometer (Thorlabs 148-811ST). The milling platform was installed on the left side of the confocal microscope and was composed of a water-cooled spindle motor (Huanyang 300 W 60K RPM) installed on a vertical translational stage (Thorlabs VAP 10/M).

Transparent embedded samples were glued on to the kinematic base top plate and locked onto the base plate under the objective. The samples were first moved along the linear guide to under the milling motor. Sample surface was milled off with a 2 mm end-cutting milling bur (eBay). The sample movement under the motor was controlled by the sample stage. The cutting depth was controlled by adjusting the vertical stage position with the micrometer. The debris was blown off and a drop of BB-BED medium was placed onto the milling surface and a coverslip was placed. After curing the newly added medium with a UV light, the sample was moved back to the objective along the linear guide. Mechanical stops were installed on the linear guide to ensure repeatable reposition. The top plane of the Z stack should be at least 25 μm below the milling surface due to the relatively higher roughness from the milling process.

No alignment was needed for the milling setup since the milling X-Y movement during the milling was controlled by the sample stage so that the milling surface was already in line with the imaging plane.

### Linear Channel Unmixing for Autofluorescence Reduction

For tissues with strong autofluorescence including skin, skeletal muscles and bones etc. linear channel unmixing was performed to distinguish true fluorescent signal from tissue autofluorescence. Autofluorescence signal widely spreads from 350 nm to 600 nm (Zipfel et al., 2003), whereas fluorescence from protein or antibody conjugation is very restricted. Depending on the endogenous fluorescence spectrum, the autofluorescence detection channel was setup at either 488 nm or 568 nm wavelength. The imaging parameters for autofluorescence detection channel were carefully adjusted so that little true fluorescence signal was detected.

The channel unmixing operation was performed with the “image calculator” function in the Image J (NIH Image J). The autofluorescence signal was subtracted from the true signal channel to generate a new channel and the new channel was combined with the previous autofluorescence channel to generate the final images. Autofluorescence signal was used for outlining tissues.

### Image Deconvolution and Stitching

Image deconvolution was accomplished with the “microvolution” module within the Slidebook 6.0 software (31 inc.). The iteration number was set as 10. Regularization was set as “none”. Blind deconvolution was checked. PSF model was automatically generated based on the optical parameter being provided.

BigStitcher module within the Image J was used for stitching imaging tiles. 10% overlapping was set up for adjacent tiles. Image stacks were exported as image sequence of .tif format. Image stacks before and after samples sectioning/milling were sequentially stitched based on the overlapping regions. For two consecutive stacks, to facilitate speed, only images sequence in the overlapping zone were selected. Pairwise stitching module of the Image J was run to stitch these selected images together. The other image sequences in the two stacks were modified their metadata (custom Image J macro code).

### Image Reconstruction and Axon Tracing

For 3-D rendering, image sequences were converted into .IMS format (Imaris Converter, Bitplane). 3-D rendering, snapshots and animation were performed with Imaris (Bitplane). Multiresolution pyramid was generated from stitched image sequences for 3-D tracing (TeraConverter, Bria et al. 2016). Manual tracing of axons was performed by a team of two annotators using TeraFly in Vaa3D (Peng et al., 2014; Peng et al., 2010). For registration, spinal cord image stacks were resliced for planes orthogonal to the rostrocaudal axis of the spinal cord. The resliced imaging plane was aligned and annotated based on the spatial map for the Allen Mouse Spinal Cord Atlases (the Allen Institute).

Axon Tracing from the Paw to the Spinal Cord

To reduce the final data size for axon tracing, the stitched imaging data was separated into three parts: 1. nerve ending in paw; 2. nerve bundle in the arm; 3. DRG and projection within the spinal cord. An overlap of 40 slices was retained in each part for the determination of axon positions. For the first part, manual 3D tracing of axons was performed with TeraFly in Vaa3d. For the second part, tracing of single axon was performed manually using stitched 2D slices in Image J. Target axon from the first part was shown in “Section” mode in Vaa3D in order to display its localization in 2D slices, and to find its counterpart in the second part. Finally, axon tracing into the DRG and its projection within the spinal cord was done manually with Terafly in Vaa3D. Each tracing procedure was performed by a team of two annotators.

### Quantification and Statistical Analysis

N number are reported in figures and legends. Data are presented as mean±standard deviation using one-way ANOVA or Student's t tests. Statistical analysis was performed in GraphPad Prism and Microsoft Excel.

### Example 1. Development of the Transparent Embedding Solvent System (TESOS)

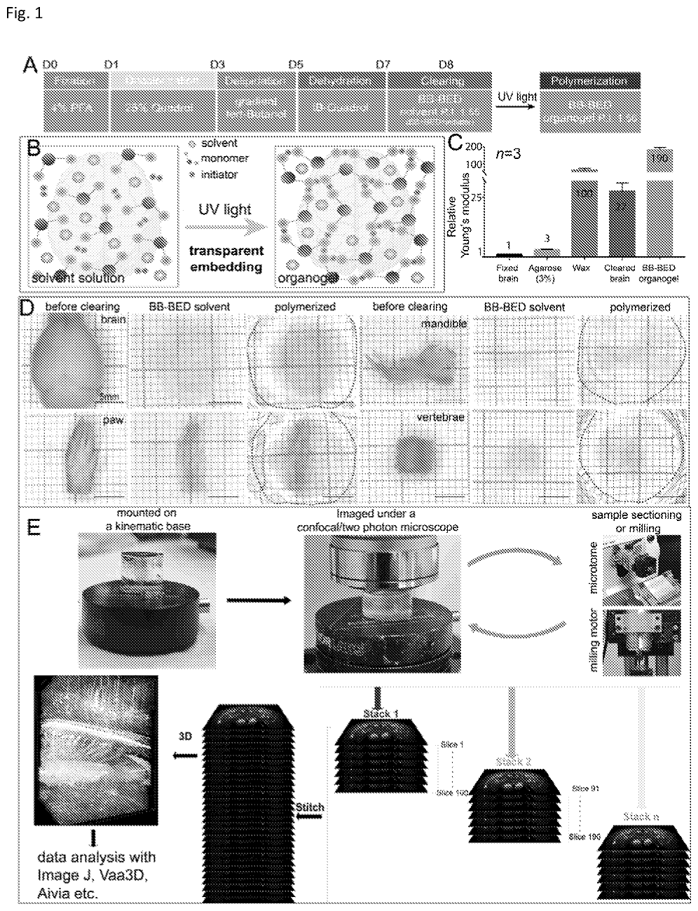

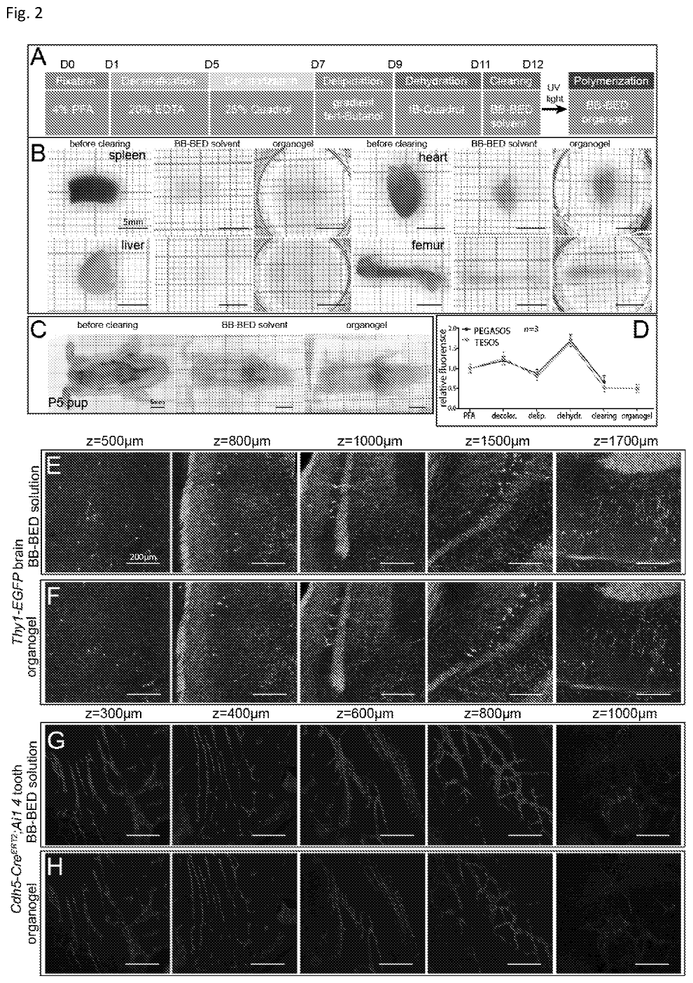

The TESOS method is a solvent based tissue clearing method designed based on our previous PEGASOS method (Jing et al., 2018). It preserved the advantage of potent clearing capability for both hard and soft tissues and incorporated the concept of “transparent embedding”. The TESOS method is consisted of multiple steps including fixation, decalcification (for hard tissue), decolorization, delipidation, dehydration and clearing (FIG. 1A). After 4% PFA fixation, 25% N,N,N′,N′-Tetrakis(2-Hydroxypropyl)ethylenediamine (Quadrol) solution was used as the decolorizing reagent to remove heme (Jing et al., 2018; Tainaka et al., 2014). We applied gradient tert-butanol (tB) solution for delipidation. We designed tB-Quadrol reagent for dehydration, which is composed of 70% tB+30% Quadrol. For final tissue clearing, we designed BB-BED468 clearing medium (RI 1.55), which is composed of 47% (v/v) benzyl benzoate (BB), 48% (v/v) of bisphenol-A ethoxylate diacrylate Mn 468 (BED468), 5% (v/v) Quadrol and then supplemented with 2% w/v of 2-Hydroxy-4′-(2-hydroxyethoxy)-2-methylpropiophenone as the UV initiator (FIG. 1A). For organs containing hard tissue, decalcification treatment with EDTA solution was included before decolorization step (FIG. 2 A). Typically, it took 8 (soft tissue organs) or 12 days (hard tissue organs) to reach final transparency. The clearing treatment rendered organs of various tissues to high transparency, including brain, mandible, mouse paw with skin, vertebrae with bone and muscles, spleen, liver, heart, femur or even whole body of mouse pups (FIG. 1D, FIG. 2B).

Bisphenol-A ethoxylate diacrylate (BED) is a commonly used monomer in dental resin due to its mechanical strength and low-toxicity. It contains acrylate groups at two ends. In the presence of UV initiator and UV light, BED molecules could be cross-linked through free radical polymerization reactions. Benzyl benzoate (BB) solvent did not participate in the polymerization reaction and was dispersed among the crosslinked polymer chains to form the organogel (FIG. 1 B). The BB-BED organogel not only was transparent by itself, but also maintained the tissues within equally transparent as in the solution (FIG. 1 D, FIG. 2B, C).

To evaluate the endogenous fluorescence change, we performed quantified assays using brain samples harvested from Thy1-EGFP mice (P60). Samples were processed following either PEGASOS or TESOS method. Fluorescent intensity after PFA fixation was normalized as one. At the end of PEGASOS or TESOS clearing process, GFP fluorescence retained ^{˜}70% of the original intensity with no significant difference between the two methods (FIG. 2D). UV initiated polymerization process has no significant impact to the GFP fluorescence (FIG. 2D).

To evaluate the impact of transparent embedding on the tissue transparency, Thy1-EGFP brain slices (FIG. 2E, F) or Cdh5-Cre^{ERT2}; Ai14 mice mandible (FIG. 2G, H) samples were imaged before and after polymerization. With a Leica 20×/0.95 immersion objective, images were acquired at the same locations of various depth. Polymerization process made no detectable impact to the image quality in both brain and hard tissue samples, indicating the tissue transparency was well maintained after polymerization.

The Young's module of brain samples was measured before and after transparent embedding. The Young's module of a cleared brain was ^{˜}25 fold stronger than a freshly fixed brain, possibly due to the dehydration process. A transparently embedded brain was over 150 folds stronger than the freshly fixed brain. In comparison, agarose strength is ^{˜}3 folds stronger than a brain. A paraffin block is ^{˜}100 folds stronger than a brain (FIG. 1C).

Therefore, the TESOS method efficiently rendered various types of tissue highly transparent and the transparent embedding treatment improved tissue strength by more than 150 folds while preserving transparency and endogenous fluorescence.

FIG. 1 shows technical pipeline of the TESOS method:
(A). Treatment steps of the TESOS method for soft tissue organs;
(B). Formation of the organogel is the conceptual basis for the process of transparent embedding. BB-BED clearing medium is mainly composed of solvent, monomer and UV initiator. UV light initiates polymerization and converts the solvent solution into organogel;
(C). Relative mechanical strength of various samples displayed as the relative Young's module. The value of freshly fixed brain was normalized as 1;
(D). Images of brain, mandible bone, paw and vertebrae samples of adult mouse before clearing, after clearing and after polymerization. Dotted lines outline the boundary of the organogel;
(E). Imaging and data processing pipeline of the TESOS method.

FIG. 2 shows that TESOS method enables transparent embedding of various tissue and organs without losing transparency and endogenous fluorescence:
(A). Treatment steps of TESOS method for mouse samples containing hard tissue;
(B). Images of spleen, heart, liver and femur harvested from adult mice before clearing, after clearing and after polymerization;
(C). A mouse pup of P5 with the brain and internal organs being removed was processed following the procedure listed in (A) and imaged before clearing, after clearing and after polymerization;
(D). Relative GFP fluorescence intensity at each step of TESOS treatment in comparison with the PEGASOS tissue clearing method;
(E, F). Thy1-EGFP mouse brain was processed with the TESOS method for soft tissue organs. Images were acquired with a 20×/0.95 NA objective at various depth before (E) and after (F) organogel polymerization;
(G, H). Femur of adult Cdh5-CreERT2; Ai14 mouse was processed with TESOS method for hard tissue organs. Images were acquired with a 20×/0.95 NA objective at various depth before (G) and after (H) organogel polymerization.

### Example 2. Process of Transparently Embedded Samples with Sectioning or Milling Platform

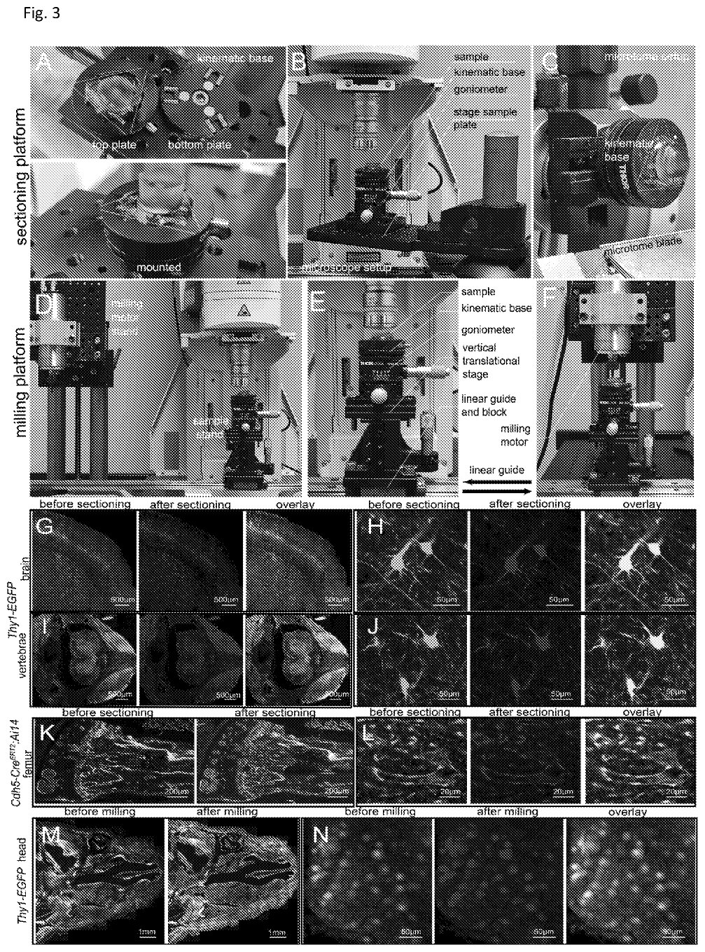

Next, based on the TESOS method, we designed and built sample processing platforms to image samples of any size at high resolution with a block-face imaging strategy (FIG. 1E). The magnetic kinematic base was originally used for re-positioning optical elements with high precision and high repeatability (FIG. 3A). Transparently embedded samples were glued onto the top plate of the kinematic base (FIG. 3A).

A kinematic base bottom plate was secured under an upright confocal/two photon microscope (FIG. 3B). Samples were mounted under the microscope through the magnetic force. The top surface of the samples was imaged like a regular sample slide. The imaging depth is determined by the working distance of the objective.

Samples were transferred between the microscope and a rotary microtome (FIG. 3C). After each sectioning, new Z stack was acquired with 10% overlapping with the previous stack. Magnetic base is the key element to ensure the samples being returned to identical positions after sectioning. We also designed alignment step to ensure the sectioning plane is parallel to the imaging plane (see details in the method part). This strategy is applicable for brain and large body trunk.

Alternatively, top surface of samples could be removed with a high-speed bur on the milling motor. The milling motor was built next to the microscope stand (FIG. 3D, E, F). Samples were moved along a linear guide between the motor and the microscope. The linear guide is the key element to ensure the sample being repositioned precisely after milling. This strategy is applicable for both soft tissue and complex tissues organs.

To evaluate if sectioning or milling distorted sample surface, we tested with brain, vertebrae, femur and complete head of adult mouse samples, which included various tissue types including skin, hair, muscle, bone and nerve. Images were first acquired at 400 μm depth for embedded brain, vertebrae or femur samples (FIG. 3G, H, I, J, K, L, before sectioning). Next, 390 μm thickness of tissue was sectioned with a microtome. Same samples were re-imaged at the same locations, which were 10 μm below the sectioning surface (FIG. 3G, H, I, J, K, L after sectioning). Overlaying of pre- and post-sectioning images indicated overall organization and very fine structures like neuron dendrites remain unchanged after sectioning (FIG. 3G, H, I, J, K, L overlay). Similar comparison was performed on adult mouse head sample processed with the milling motor setup. Overall structures and fine cellular structures also remained unchanged after milling treatment (FIG. 3M, N).

Sectioning or milling process did not cause detectable tissue distortion, which enabled adjacent image stacks to be stitched based on overlapping layers to reconstruct a complete image.

FIG. 3 shows microtome and milling platforms for sectioning or milling embedded samples:
Kinematic magnetic base was used for sample mounting and transferring. Embedded sample was glued onto the top-plate of a kinematic magnetic base. Two bottom-plates were secured under microscope and microtome respectively. Top-plate with the sample was transferred between these two bottom plates. The magnetic design enables the top plate to automatically reposition to an exact location with high repeatability;
(A). Kinematic magnetic base with the two parts separated (top panel) or mounted (lower panel);
(B). Description of parts when the sample was mounted under the microscope;
(C). Description of parts when the sample was transferred to the microtome;
On a milling platform, milling motor was built next to the microscope. The sample was moved between the microscope and milling motor along a high precision linear guide;
(D). Description of parts for the milling setup;
(E). Description of parts when the sample was under the microscope;
(F). Description of parts when the sample was under the milling motor;
(G-N). Transparent embedding enables sectioning or milling process with no detectable tissue distortion:
The brain of adult Thy1-EGFP mouse was processed and embedded following the TESOS method for soft tissue organs. The vertebrae, femur and the head samples were all harvested from adult mice and embedded following the TESOS method for hard tissue organs. Images were acquired with a 10×/0.4 NA air or 20×/0.95 NA immersion objective before and after tissue was sectioned/milled off. Imaging planes before sectioning/milling were 400 μm below the surface. Samples of 390 μm thickness were sectioned. Samples of 380 μm thickness were milled off;
(G). The embedded brain was imaged before and after sectioning with 10× objective. Two images were overlaid to display unchanged morphology;
(H). Selected neurons were re-imaged with 20× objective;
(I). The vertebrae sample was imaged with 10× objective before and after sectioning and then overlaid;
(J). Selected neurons within spinal cord were imaged with 20× objective to display unchanged neurons morphology;
(K). Images of femur were acquired with 10× objective before and after sectioning;
(L). Selected regions in femur were re-imaged with 20× before/after sectioning;
(M). The head sample was imaged before and after milling;
(N). Selected ganglion neurons were re-imaged with 20× objective to display consistent morphology.

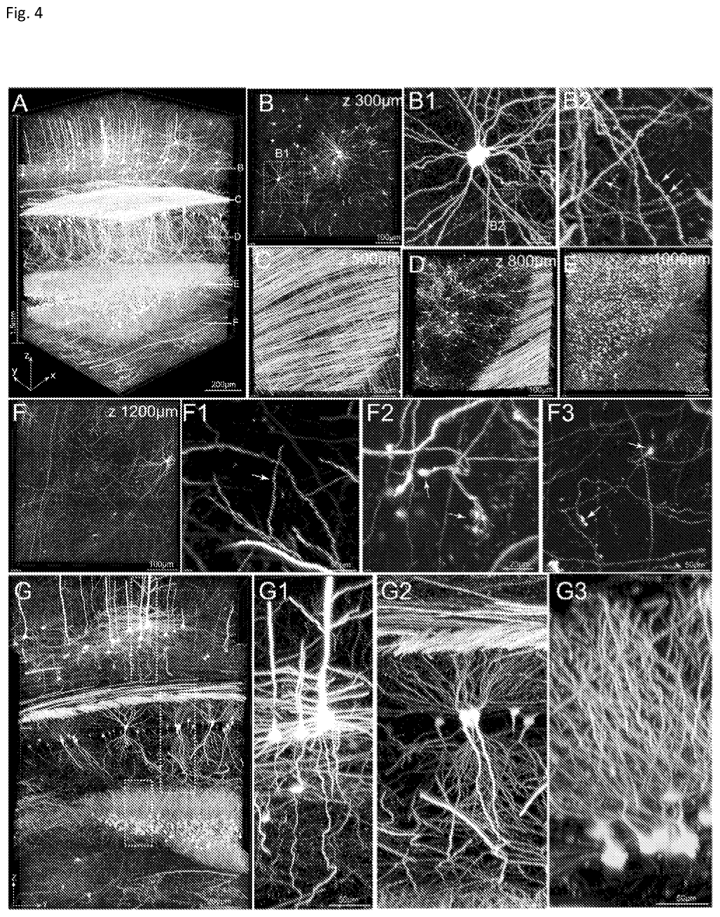

FIG. 4 shows sub-micron resolution imaging of Thy1-EGFP brain sample. Adult Thy1-EGFP mouse brain sample of 1 mm (x)×1 mm (y)×1.5 mm (z) size was processed and imaged with a 40×1.3 NA objective (voxel size 0.26 μm×0.26 μm×1.2 μm):
(A) The final image stack was stitched from 8 stacks with 240 μm thickness for each stack;
(B-F). Sub-blocks (size: x−1 mm, y−1 mm, z−0.2 mm) were acquired at various Z positions indicated with white lines in (A) and displayed in x-y orientation. Boxed region in (B) was enlarged in (B1). Boxed region in (B1) was resliced and enlarged in B2 to display dendritic spines (arrows). Region in (F) was resliced and enlarged to display dendritic spines (arrow in F1) and boutons (arrows in F2 and F3);
(G). A sub-block (x−200 μm, y−1 mm, z−1.5 mm) was displayed in y-z orientation. Boxed regions were enlarged to display descending neurons (G1), pyramidal neurons (G2) and granule cells (G3) respectively.

### Example 3. Sub-Micron Resolution Imaging of Mouse Brain, Bone and Vertebrae Samples

We applied TESOS method on organs of different tissue types. Thy1-EGFP mouse brain sample of 1 mm×1 mm×1.5 mm size was processed with the TESOS method and imaged with a Zeiss 40×/1.3 NA objective with voxel size of 0.26 μm×0.26 μm×1.2 am. The final image stack was stitched from 8 stacks (FIG. 4A). Optical slices indicated high quality images were acquired at all z depth (FIG. 4B-F). Dendritic spines and boutons could be visualized at either 300 μm or 1200 μm depth (FIG. 4B2, F1, F2, F3). Y-Z optical slice indicated structure continuity in Z dimension was not disrupted by sectioning. Axons and dendrites remained continuous and intact in Z dimension (FIG. 4G, G1, G2, G3).

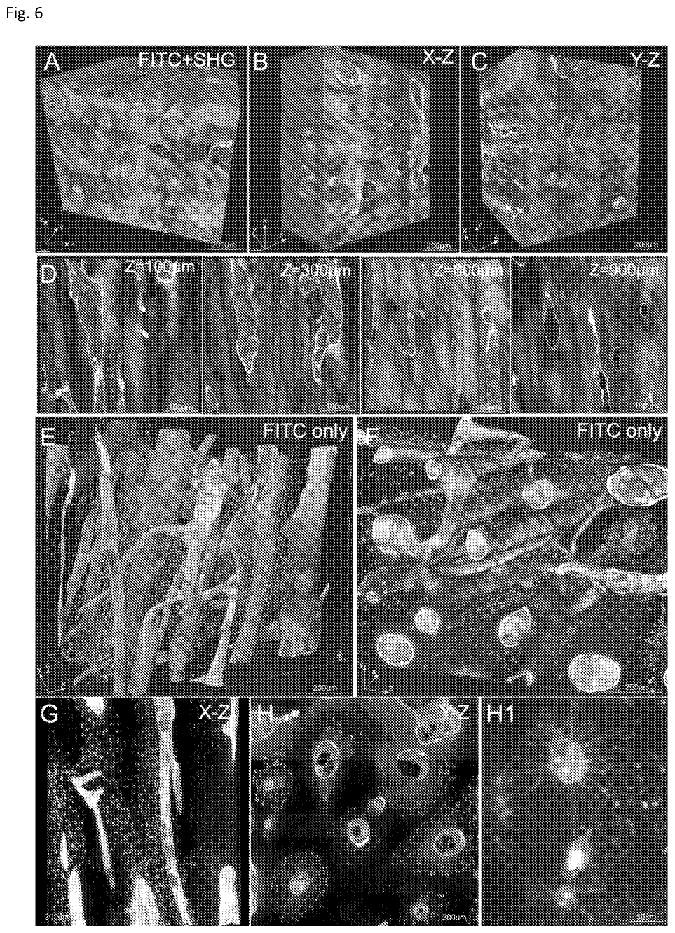

A human bone sample (1 m×1 mm×1 mm) was stained with FITC to reveal the osteocytes and Haversian Canal system. Sample was processed following the TESOS method for hard tissue organs and imaged on a Zeiss upright two-photon microscope with 40×/1.3 NA objective. The final image was stitched from 6 stacks in Z dimension (FIG. 6A-C). Optical slices acquired on various depth displayed equally high resolution (FIG. 6D). The Haversian Canal system with surrounding osteocytes were revealed through FITC staining (FIGS. 6E, F). X-Z and Y-Z optical slices indicated continuous structure in Z dimension. Sectioning did not distort cellular organization (FIG. 6H1).

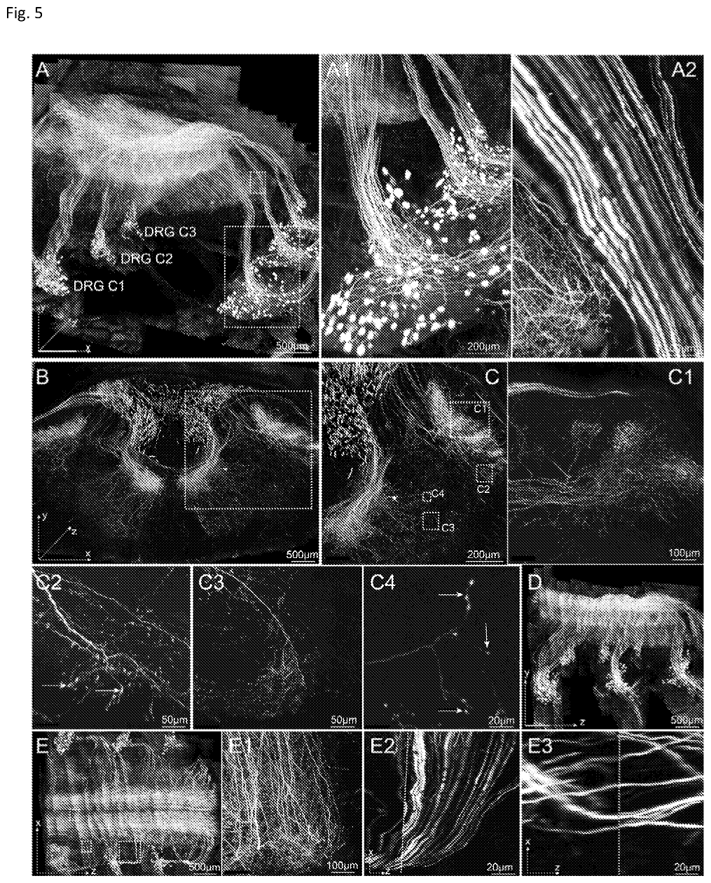

Shh-Cre^{ERT2}; Ai140 mice were used to label DRG neurons within spinal cord specifically. Adult mice were induced with tamoxifen and the cervical vertebrae segment including both spinal cord and surrounding bones were harvested. After transparent embedding, the sample was imaged with Leica 40×/1.3 NA objective at 0.37 μm×0.37 μm×1.2 am voxel size. We performed linear channel unmixing to distinguish autofluorescence from GFP signal. The final image stack (3.5 mm×2.2 mm×3 mm) was stitched from 22 stacks in Z dimension (FIG. 5A). Fine neural structures were clearly visualized, including the DRG neuron soma (FIG. 5A1), central axonal branch (FIG. 5A2), axonal arbor (FIG. 5B, C, C1) and boutons (FIG. 5C1-C4). The image was continuous on Z dimension (FIG. 5D, E). Fine structures including arbor and axons remains intact and continuous in Z dimension (FIG. 5E1-E3).

These results indicated that TESOS method is applicable for organs of various tissue types and enabled sub-micron resolution imaging for large samples.

FIG. 5 shows DRG sensory neurons and their projections in the spinal cord. Adult Shh-Cre^{ERT2}; Ai140 mouse vertebrae segment containing spinal cord, bones, attached muscle and skin (3.5 mm×2.2 mm×3 mm) was processed for transparent embedding. A 40×/1.3 NA oil immersion objective was used for imaging (voxel size 0.37 μm×0.37 μm×1.2 μm) (gold, GFP signal; blue, autofluorescence):
(A). Cervical DRG pairs from C1 to C3 were included in the reconstructed 3-D images. Gold color. GFP signal. Blue, autofluorescence. Boxed regions were enlarged in A1 and A2;
(B). A sub-block of 500 am thickness was displayed to show the dense projections of DRG neurons in the spinal cord;
(C). Boxed regions in (B) were enlarged to show details. Boxed regions in (C) were enlarged or resliced in C1, C2, C3 and C4 to show axon arbor in C. Axonal bouton could be clearly visualized (arrows in C2 and C4);
(D and E). Y-Z view and X-Z view of the image stack was displayed. Boxed regions in (E) were resliced or enlarged in E1, E2 and E3 respectively. Dotted lines in E2 and E3 indicated boundaries between two stitched adjacent stacks in z-dimension.

FIG. 6 shows high resolution imaging of the human bone sample stained with fluorescein isothiocyanate dye (FITC). Human femur bone sample of 1 mm (x)×1 mm (y)×1 mm (z) size was stained with FITC dye and processed following the TESOS method for hard tissue organs. Embedded bone was imaged under a Zeiss two-photon microscope with a 40×1.3 NA objective with the voxel size 0.4 μm×0.4 μm×1.2 μm. (Gold, FITC stain; light blue, second harmonic generation (SHG) signal):
(A) The final image stack was stitched from 6 stacks with 240 μm thickness for each stack;
(B, C). Sub-blocks acquired in x-z (B) or y-z (C) dimension;
(D). Slices were acquired at various z-depth;
(E, F). FITC staining was displayed alone to show the Haversian Canals system in 3-dimension;
(G, H). x-z or y-z optical slices were acquired. Boxed region was resliced and enlarged in (H1). Dotted line indicated boundaries between two stitched adjacent stacks in z-dimension.

### Example 4. TESOS Method is Compatible with Immunofluorescence Staining

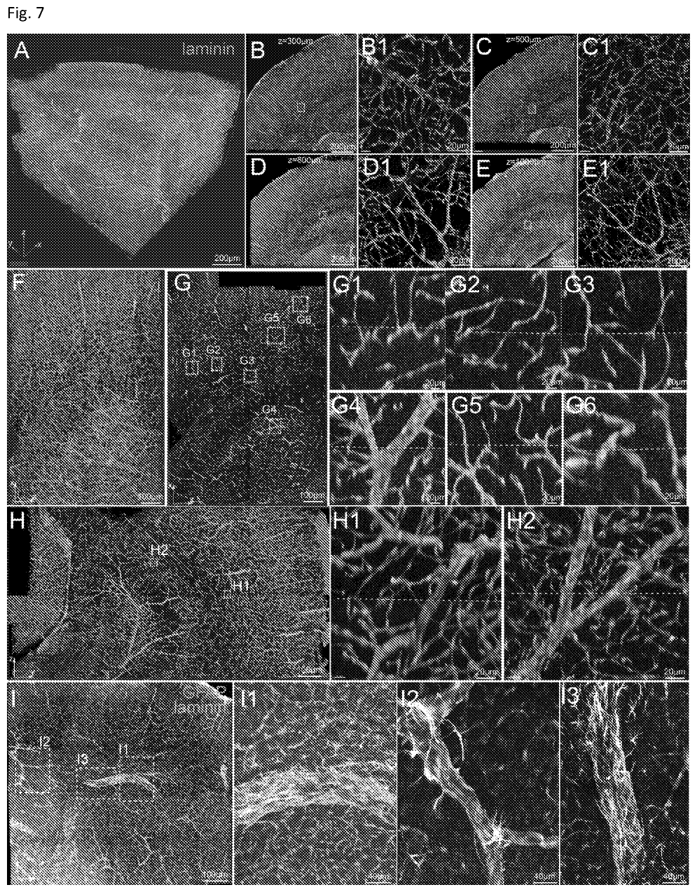

We further tested if the TESOS method is compatible with immunofluorescent staining. Thick brain slice (1.5 mm×1.5 mm×1.0 mm) of adult mice were performed wholemount immunofluorescent staining with antibodies against laminin for vasculature labelling. Samples were processed with the TESOS and imaged with a 40×1.3 NA objective on a confocal microscope method in combination with sectioning microtome. Final image stack was stitched from 6 stacks in Z dimension (FIG. 7A). X-Y optical slices acquired at various depth showed comparable staining signal of vasculature at all depth (FIG. 7B, B1, C, C1, D, D1, E, E1). Sub-block on x-z dimension showed continuous vasculature staining signal in Z dimension (FIG. 7F). X-Z optical slice also showed that vasculatures staining signal was consistent and the structure remained continuous at all stitching boundaries (FIG. 7G, G1-G6). We also performed double immunofluorescent staining for mouse brain slice with antibodies against laminin and GFAP. The vasculature and glial cells were clearly displayed (FIG. 71, 11-13), which indicated that the TESOS method is compatible with immunofluorescent staining.

FIG. 7 shows high resolution imaging of samples stained with antibodies. A piece of mouse brain with 1.5 mm×1.5 mm×1.0 mm dimension was performed whole mount immunofluorescent staining with antibodies against laminin (A-H) or laminin+GFAP (I). Samples were processed with the TESOS method and imaged under a confocal microscope with a 40×/1.3 NA objective. Voxel size is 0.4 μm×0.4 μm×1.2 μm:
(A). Reconstructed final image stack of 1.5 mm(x)-1.5 mm(y)-1.0 mm(z) dimension was stitched from 6 stacks with 200-240 μm thickness for each stack;
(B-E). Optical slices in x-y orientation were acquired at various depth. Boxed regions were enlarged (B1-E1);
(F) A sub-block of 1.5 mm(x)-0.5 mm(y)-1.0 mm(z) was displayed in x-z orientation;
(G). An optical slice in x-z orientation. Boxed regions were selected at the boundary between adjacent z-stacks and enlarged in (G1-G6). Dotted lines indicated boundaries between two stitched adjacent stacks in z-dimension;
(H). An optical slice in y-z orientation. Boxed regions were enlarged in (H1) and (H2). Dotted lines indicated boundaries between two stitched adjacent stacks in z-dimension;
(I) Reconstructed final image stack for brain sample stained with GFAP+laminin antibodies. Boxed regions were enlarged in (I1-I3).

### Example 5. Whole-Body Imaging of Mouse Pup at Micron-Scale Resolution

Thy1-YFP-16 mouse pup of P5 age was collected. The brain and internal organs were removed to facilitate penetration using an immersion protocol. All other tissues remained intact including skin, muscle, bones, eyeballs etc. (FIG. 2C). Samples were processed following TESOS method for hard tissue organs. The body trunk turned transparent after 2 weeks and remained equally transparent after transparent embedding initiated with UV light (FIG. 2C).

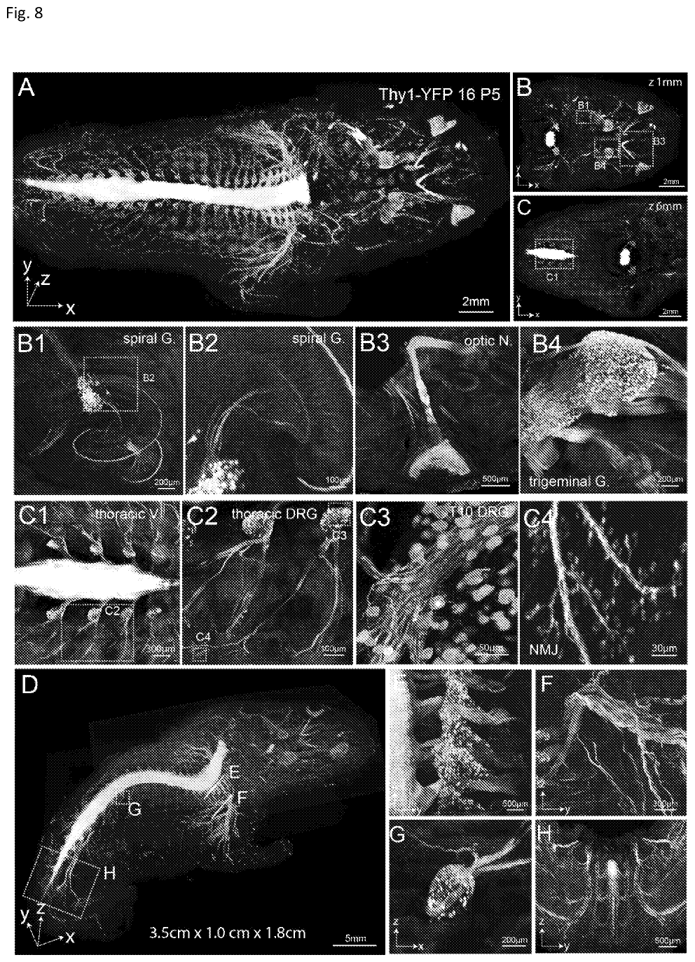

The sample was imaged with a Leica 20×/0.95 immersion objective on a Leica confocal microscope. The milling motor platform was used to remove surface tissue. The final image stack of 3.5 cm(x)×1.0 cm (y)×1.8 cm (z) size was stitched from 40 stacks with ^{˜}500 μm thickness for each stack (FIG. 8A, F). The voxel size was 0.9 μm×0.9 μm×3.5 am. Optical sections were acquired at various depth showing consistent resolution throughout the entire sample (FIG. 8B, C). At 1 mm Z depth, neuron somas of the spiral ganglion were clearly visualized together which their axons innervating hair cells (FIG. 8B, B1, B2). In addition, retina, optic nerves, and trigeminal ganglions were also clearly displayed with soma and axon bundles being clearly shown (FIG. 8B3, B4). At 6 mm Z depth, thoracic segment of the spinal cord was displayed. Enlarged images clearly showed the thoracic DRG neurons and the neuromuscular junction (NMJ) structures (FIG. 8C, C1-C4). To display the structure continuity in Z dimension, the image stack was displayed in lateral view (FIG. 8D) and Y-Z or X-Z optical slices were acquired at different locations. Y-Z optical slice showed 4 cervical DRGs (FIG. 8E). Y-Z or X-Z slices also displayed intact structures of L1 DRG, branchial plexus and sciatic nerves (FIG. 8F, G, H).

Therefore, the TESOS method in combination with milling platform enabled the micron-scale resolution imaging of whole body composed of various tissue types.

FIG. 8 shows hole body imaging at micron scale resolution. Brain and internal organs were removed from a Thy1-YFP-16 mouse pup of P5. The body trunk was processed and imaged with a 20×0.95 NA oil immersion objective (gold, YFP signal; blue, autofluorescence):
(A). Final image stack of 3.5 cm(x)×1.0 cm (y)×1.8 cm (z) was stitched from 40 stacks with ^{˜}0.5 mm thickness for each stack. Voxel size is 0.9 μm×0.9 μm×3.5 am;
(B-C). Image in (A) was re-sliced at 1 mm (B) or 6 mm (C) Z-depth. Boxed regions were enlarged to display details. (B1). Spiral ganglion. Boxed region was enlarged in (B2) to show axons innervating hair cells. (B3). Optic nerve and retina. (B4). Trigeminal ganglion. (C1). Thoracic vertebrae. Boxed region was enlarged in (C2) to show two thoracis ganglions. Boxed regions in (C2) were enlarged to show the T10 DRG (C3) and the NMJ (C4);
(D-H). Lateral view of the image stack (D). Boxed regions were resliced in Y-Z dimension to show the thoracis DRGs (E), branchial plexus (F), DRG T10 (G) and the sciatic nerve (H).

### Example 7. Reconstruction of Sensory Field of Individual Sensory Nerve Axons on Intact Mouse Paw

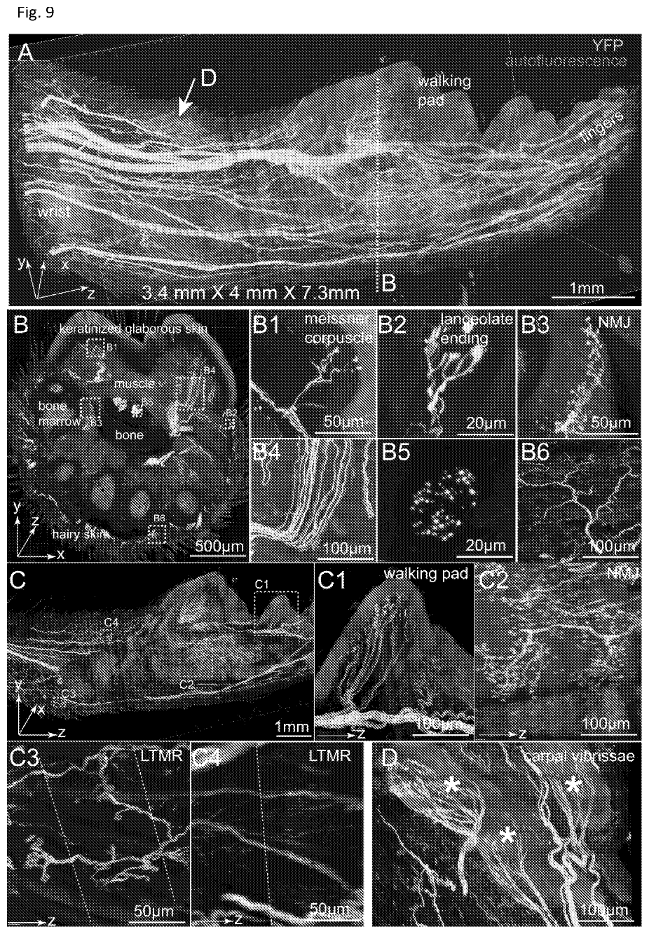

Thy1-YFP16 mouse strain was known to label part of low threshold mechanical receptor (LTMR) neurons and endings of hairy skin and Meissner corpuscles of glabrous skin (Taylor-Clark et al., 2015). Intact forepaw of an adult Thy1-YFP16 mouse was processed with the TESOS method for hard tissue organs. All tissue including hair, skin, muscle, bones and nerves was preserved. The sample was imaged with a Leica 40×/1.3 NA objective on a Leica Sp8 confocal microscope. A sectioning microtome was used to remove surface tissue. The final image stack of 3.4 mm(x)-4 mm(y)-7.3 mm(z) dimension was stitched from 35 stacks (FIG. 9A). The voxel size was 0.4 μm×0.4 μm×1.2 μm. Linear channel unmixing was used to distinguish GFP signal from autofluorescence derived from skin and skeletal muscles. A sub-block of 500 μm z depth was displayed (FIG. 9B). Boxed regions were enlarged or re-sliced to display different types of nerve endings including Meissner corpuscles within the walking pad (FIG. 9B1), lanceolate ending surround the hair (FIG. 9B2), NMJ (FIG. 9B3), nerve axons in longitudinal direction (FIG. 9B4), cross section of nerve axons (FIG. 9B5) and branches of sensory nerve axon under the skin (FIG. 9B6). To display the tissue integrity and continuity, optical slice was acquired in Y-Z dimension (FIG. 9C). Boxed regions were enlarged to display sensory nerves innervating a walking pad (FIG. 9C1), NMJ on the muscle (FIG. 9C2) and LTMR nerve axons under the hairy skin (FIG. 9C3, C4). There are three carpal vibrissae located at the wrist of the forearm which sense the forearm position (FIG. 9A) (Niederschuh et al., 2015). We were able to visualized nerve axons innervating the three carpal vibrissae (asterisks in FIG. 9D) (Niederschuh et al., 2015).

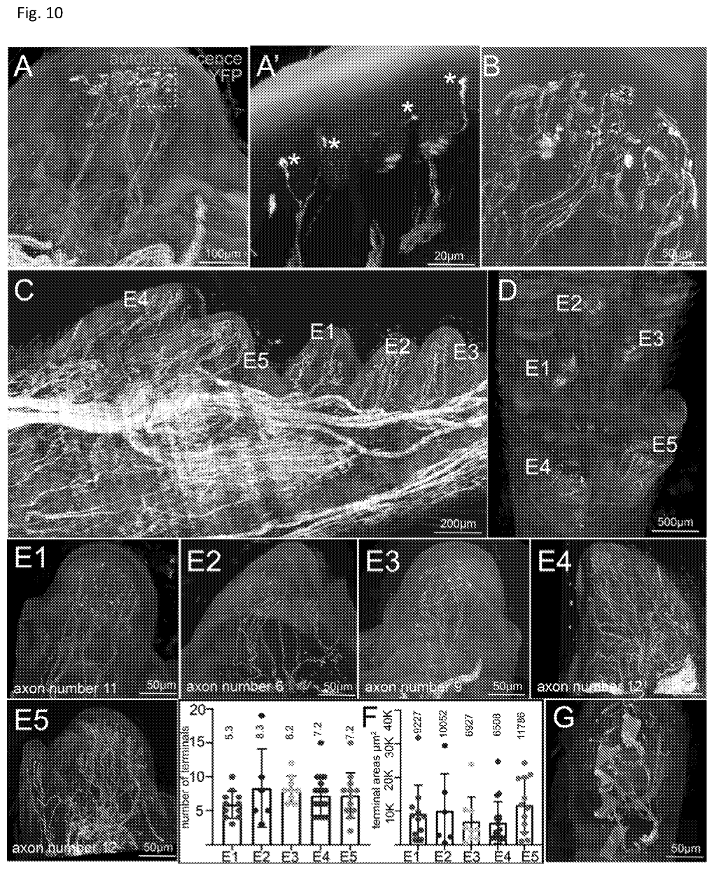

The image stack was analyzed in Vaa3D. Nerve axons and endings were visualized within the glabrous skin of walking pad (FIG. 10A). All the axons under the glabrous skin of walking pad are sensory axons innervating Meissner corpuscles based on their morphology and localization within the dermal papillae (FIG. 10A′). All endings derived from individual axon could be traced (FIG. 10B). We traced all the labelled axons within the five walking pads on mouse forepaw (FIG. 10C, D). Around 5-15 sensory axons were labelled within each walking pad (FIG. 10E1-E5). Each axon innervated 7.2±3.14 Meissner corpuscles on average. The average area of receptive field for each axon is 8620±7820.80 μm² (FIG. 10F). The receptive fields between axons did not overlap (FIG. 10G).

FIG. 9 shows nerves within the forepaw of an adult Thy1-YFP16 mouse. An intact forepaw including the skin and hair was acquired from an adult Thy1-YFP16 mouse. The sample was processed and imaged with a 40×/1.3 NA objective (voxel size 0.4 μm×0.4 am×1.2 am). The digits were not included in the image. Yellow, YFP signal; Red, autofluorescence:
(A). Reconstructed final image stack of 3.4 mm(x)-4 mm(y)-7.3 mm(z) dimension was stitched from 35 stacks with 200-240 μm thickness for each stack;
(B). A sub-block of 500 μm thickness in z (dotted line in A), was displayed in x-y orientation. Boxed regions were enlarged or re-sliced to display various structures including Meissner corpuscle (B1), lanceolate ending surrounding a hair follicle (B2), neuromuscular junction (NMJ) (B3), nerve bundles in longitudinal dimension (B4), nerve bundles cross section (B5) and a sensory axon with its branches under the skin (B6);
(C). A sub-block of 200 μm thickness in x was displayed in y-z orientation to display the structure continuity in the z-dimension. Boxed regions were enlarged or re-sliced to display various structures including sensory nerves within a walking pad (C1), NMJ (C2), LTMR innervating hair follicles (C3) and LTMR axons (C4). Dotted lines in (C3) and (C4) indicated boundaries between two stitched adjacent stacks in z-dimension;
(D). Sensory nerves innervating the three carpal vibrissae (asterisks) at the wrist position (arrow in A).

FIG. 10 shows tracing of sensory axons innervating Meissner Corpuscles under the five walking pads of adult Thy1-YFP16 mouse forepaw:
(A). A sub-block from the same image stack in FIG. 5 was acquired to display a walking pad and their innervating nerve axons. Boxed region was resliced in (A′) to show the morphology of the Meissner corpuscles (asterisks) and their localization within the dermal papillae;
(B). Tracing of one sensory axon and all of its derivative branches and terminals with Vaa3D;
(C, D). Tracing of all the sensory axons within the five walking pads (labelled as E1-E5) displayed from lateral (C) or ventral (D) view;
(E1-E5). Tracing results of the five walking pads was individually displayed;
(F). Quantification of average terminal number from one sensory axon (left panel) and average receptive field area of one sensory axon (right panel);
(G). The non-overlapping tiling pattern of different sensory axons receptive fields in walking pad E1.

### Example 8. Reconstruction and Mapping of Complete Projection of Single DRG Neurons within the Spinal Cord

Synapsin-Cre AAV was injected under the glabrous skin of the walking pads of Ai140 mice forepaws. Different AAV titers were provided for left or right side. Two months later, the complete cervical and thoracic vertebrae segments including spinal cord and surrounding tissues were collected to preserve intact DRG to spinal cord connections. Transparently embedded samples were imaged with a 40×/1.3 NA objective under a Leica Sp8 confocal microscope. Microtome sectioning was used to remove surface tissue. Final image stack of 2.5 mm×3.8 mm×6 mm was reconstructed from 28 stacks in z dimension. The voxel size was 0.4 μm×0.4 μm×1.2 μm.

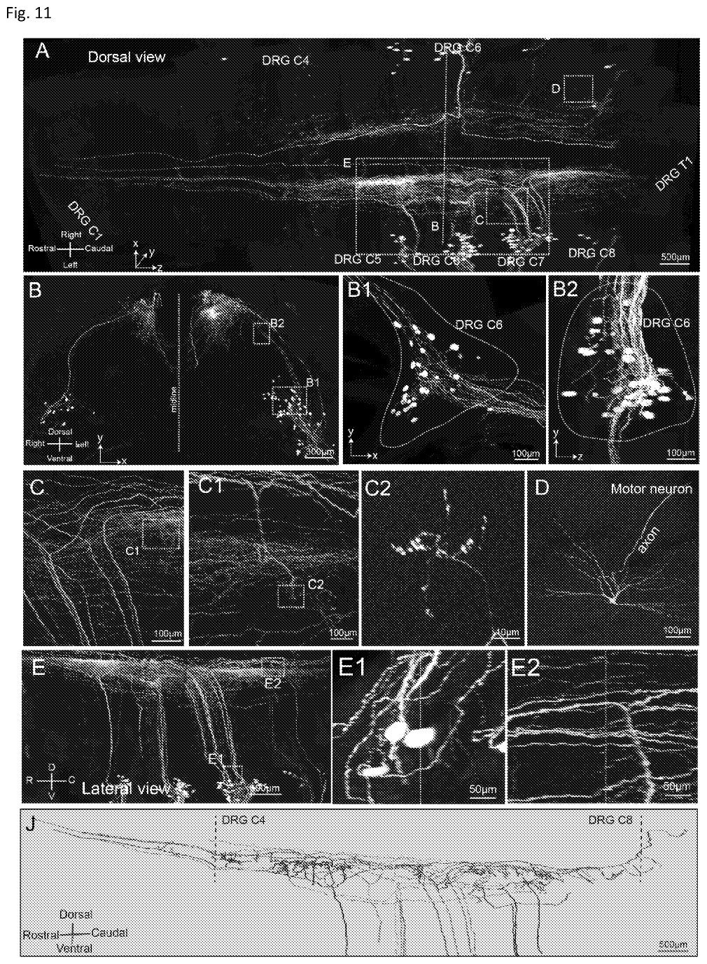

All labelled neurons were located between DRGs C5-C8. Central projections were mostly between C4 and C8 segment (FIG. 11A). X-Y sub-block showed the central projections are restricted to the medial side of the spinal cord (FIG. 11B). DRG neurons of various sizes were labelled with no obvious spatial pattern (FIG. 11B1, B2). All parts of the neuron were visualized, including DRG central axons, collateral branches, arbors and boutons (FIG. 11B1, B2, C, C1, C2). A motor neuron was also labelled with dendrites and axon clearly displayed (FIG. 11D). Lateral view of the image stack indicated that sectioning process did not disrupt the structural continuity. Reconstructed neuron soma and axon remained intact and continuous in z dimension (FIG. 11E, E1, E2).

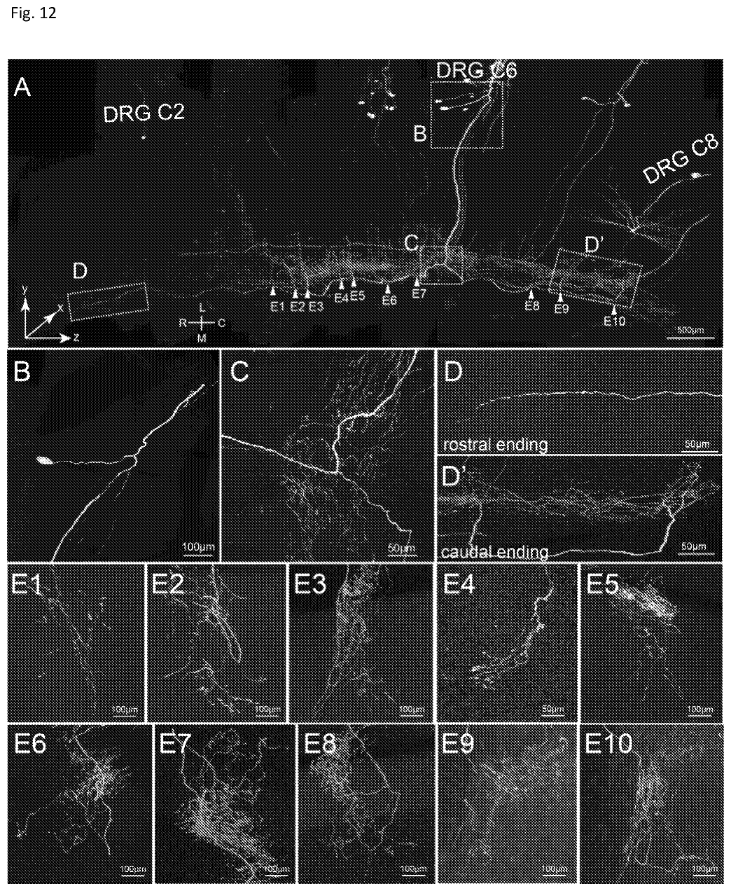

All fine details of single neurons could be identified (FIG. 12A). A sensory neuron in the DRG C6 gave rise to central and peripheral axons (FIG. 12B). The central axon bifurcated to form a caudal and a rostral branch (FIG. 12C). The caudal branch extended from DRG C6 to DRG C8, gave rise to 3 collateral branches with arbors and ended with an arbor (FIG. 12D). The rostral branch extended from DRG C6 to DRG C2, gave rise to 7 collateral branches with arbors and ended as a free terminal with no arbor (FIG. 12D′). All the 10 collateral branches with their arbors were displayed (FIG. 12E1-E10).

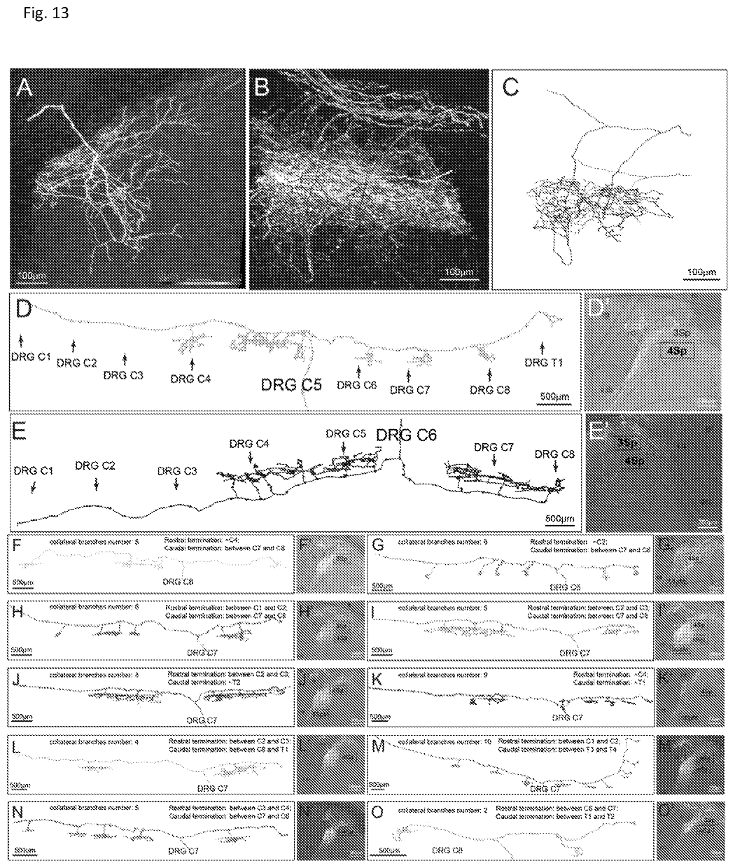

Sparse labeling and high-resolution imaging enabled us to outline and trace axon arbors in its entirety with Vaa3D (FIG. 13A). We were able to visualize the spatial overlap between central projection arbors of adjacent collateral branches from the same neuron (FIG. 13B). We also visualized spatial overlap between projection arbors from two different DRG neurons (FIG. 13C).

We outlined the complete central projection arbors of 12 DRG neurons (FIG. 11J, FIG. 13). The findings are summarized in below: (1) Most of the arbors are localized between DRG C4 and T1 segment (10/12) (FIG. 13D, E, F, G, H, I, K, L, N, O). No arbor was visualized rostrally beyond DRG C2. (2). The axon arbor all projected into medial side of the spinal cord on laminae 3, 4 or 5 (FIG. 13D′-O′). (3). The collateral branches and arbors are not evenly distributed along the axons. Rostral branches can extend 2-3 mm without collateral branches or arbors (FIG. 13D, E, G, I, K, L, M) (4). None of rostral branches extended beyond DRG C1 position into the brainstem. Most of them (9/12) ended as free terminal without arbor (FIG. 13D, E, G, H, I, J, K, L, M). (5). Most caudal branches ended as arbors (9/12) (FIG. 13D, E, F, G, H, I, J, K, M).

FIG. 11 shows complete projections of single sensory neurons in the spinal cord. DRG neurons were labelled by injecting adult Ai140 mice with Synapsin-Cre AAV at the walking pad position. Lower AAV dosage was given to the right side than the left side. Cervical vertebrae was collected two months after injection and processed for imaging with a 40×/1.3 NA objective (voxel size 0.4 μm×0.4 μm×1.2 am). (Gold, GFP signal; Blue, autofluorescence):
(A). Reconstructed final image stack of 2.5 mm×3.8 mm×6 mm dimension was constructed from 28 stacks with 200-240 μm thickness for each stack;
(B). Caudal view of the image stack. Boxed regions were enlarged or re-sliced to display details including DRG neurons (B1, B2);
(C). Bifurcations of DRG neuron central branches. Boxed regions in (C) were enlarged to display axon arbor (C1) and boutons (C2);
(D). A motor neuron that was randomly labeled;
(E). Lateral view of the image stack. Boxed regions were enlarged to display DRG neurons (E1) and axons (E2). Dotted lines in E1 and E2 indicated boundaries between two stitched adjacent stacks in z-dimension;
(J). Complete projection of 12 DRG neurons within the spinal cord.

FIG. 12 shows complete projection of one sensory neuron within the spinal cord. The sample was the same as the one in the FIG. 11:
(A). A sensory neuron within C6 DRG and its projection within the spinal cord was displayed. Boxed regions were enlarged in following panels;
(B). The soma and the bifurcations of peripheral branch and central branch;
(C). The central axon branch bifurcated into caudal and rostral branches;
(D, D′). The rostral (D) and caudal (D′) termination of the axon;
(E1-E10). The 10 collateral branches and their arbors. The locations were indicated in (A).

FIG. 13 shows complete projection mapping of twelve sensory neurons within the spinal cord. Axon arbors were traced with Vaa3D:
(A). Color coded depth showing the spatial distribution pattern of an axon arbor;
(B). Arbors from two adjacent collateral branches derived from the same neuron;
(C). Spatial overlapping of arbors from two neurons;
(D-O). Complete tracing of 12 sensory neurons within the spinal cord. Eleven were from the left DRGs C5-C8 (E-O) and one was from the right side DRG C6 (D);
(D′-O′). Projections of arbors were mapped with the Allen spinal cord atlas. Boxed label indicated projection laminae. Collateral branches number, positions of rostral and caudal terminations were described in each figure.

### Example 9. Reconstruction of Long-Range Projection of Sensory Neurons from Forepaw to Spinal Cord

Sensory neurons in the DRGs send out axons to both peripheral organs and spinal cord spanning a very long range. To outline the complete sensory neuron projections, adult Thy1-EGFP mice were used. The forepaw, forearm, cervical and thoracic vertebrae were isolated with all tissues in place. Samples were processed following the TESOS method for hard tissue organs. Processing time for each step was doubled to assure complete penetration. Samples were transparently embedded and imaged with a 40×/1.3 NA objective on a Leica Sp8 confocal microscope with the voxel size 0.4 μm×0.4 μm×1.5 μm. The milling motor setup was used for removing surface tissue.

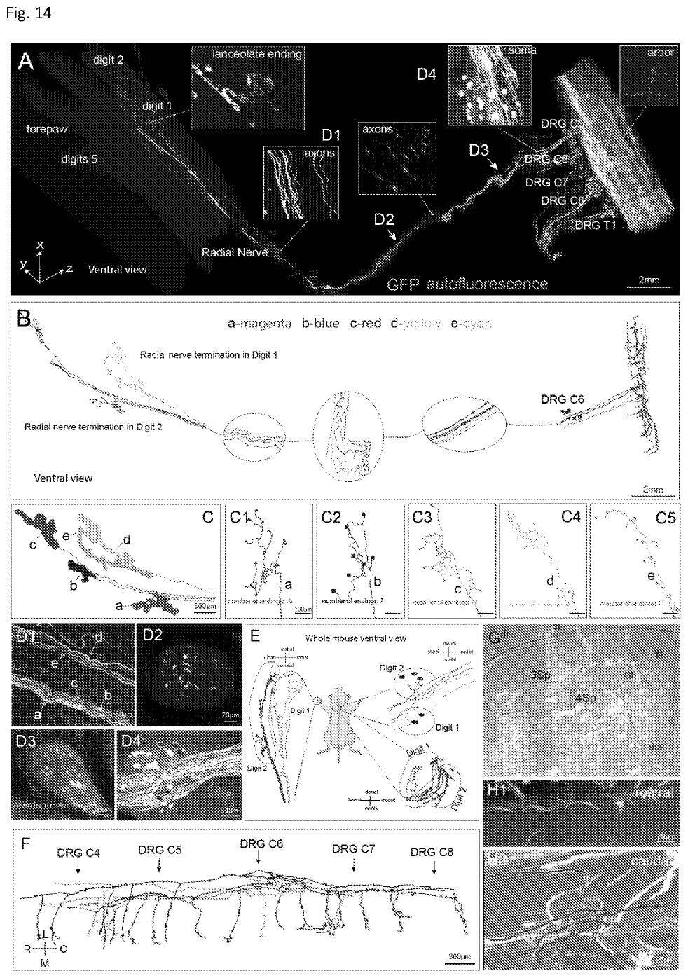

The final image stack (2.5 cm×1.8 cm×2 cm) was stitched from 98 stacks including the entire forepaw, the radial nerve, part of branchial plexus, DRG and spinal cord (FIG. 14A). Comparing with Thy1-EYFP-H or Thy1-YFP16 mouse strains, neuron labelling of Thy1-EGFP mice was sparser. LTMR sensory endings and axons were recognized through lanceolate endings surrounding hair follicles (FIG. 14A). The forearm section was selectively imaged surrounding the radial nerve. Small portion of nerve axons within the radial nerve was labelled which made the axon tracing possible (FIG. 14A, D1, D2, D3, D4). Spinal cord segment between C2 and T2 was imaged.

Axons tracing was performed with Vaa3D. Finally, we were able to reconstruct complete projection courses of five DRG neurons with confidence. The entire tracing courses were ^{˜}5.5 cm from forepaw digits 1 and 2 to the DRGs and extended ^{˜}5 mm in the spinal cord (FIG. 14B).

The receptive fields of the five LTMR neurons were longitudinal along the digit axis (FIG. 14C). Numbers of lanceolate ending ranged from 7 to 26 (FIG. 14C1-C5). The target axons were traced within the radial nerve all the way to the branchial plexus and to the DRG C6 (FIG. 14D1-D4). The spatial relationship of the five axons were not constant within the radial nerve. The neuron somas innervating digit 1 were localized more caudally than those of digit 2 (FIG. 14E). The projection fields were mostly in the middle of lamina 3 (3Sp) and lamina 4 (4Sp). Projection fields of digit 2 were localized medial than those of digit 1 (FIG. 14G, E). In the rostral-caudal direction, projections of these LTMR neurons extended from DRG C3 to DRG C8 and each of them gave rise to 3^{˜}8 collateral branches (FIG. 14F). None of their rostral branches extended beyond C3. Their rostral branch ended as free terminal and caudal branches ended as arbors (FIG. 14H1, H2).

1. A reagent for clearing tissue or organ, comprising organic solvent and monomer crosslinker for forming organogel,
preferably, the tissue or organ is any of tissue or organ of the animal, including but not limited to skin, hairy, muscle, bone, nerve, brain, paw, spinal cord, vertebrae, mouse paw with skin, vertebrae with bone and muscles, spleen, liver, heart, eyeball, complete head of adult mouse, or even whole body of mouse pup.

2. The reagent for clearing tissue or organ of claim 1, wherein the organic solvent is benzyl benzoate; and/or
wherein the monomer crosslinker is selected from polyethylene glycol dimethacrylate, polyethylene glycol diacrylate, diethylglycol diacrylate, diethylene glycol dimethacrylate, ethyleneglycol diacrylate, ethylene glycol dimethacrylate, bisphenol-A ethoxylate dimethacrylate, bisphenol-A ethoxylate diacrylate, bisphenol-A glycidyl methacrylate and bisphenol-A glycidyl acrylate.

3. (canceled)

4. The reagent for clearing tissue or organ of claim 1, wherein the organic solvent is benzyl benzoate, and the monomer crosslinker is polyethylene glycol diacrylate or bisphenol-A ethoxylate diacrylate, preferably, the monomer crosslinker is bisphenol-A ethoxylate diacrylate, more preferably, the bisphenol-A ethoxylate diacrylate is bisphenol-A ethoxylate diacrylate having Mn of 468 or 512.

5. The reagent for clearing tissue or organ of claim 1, which comprises 40-55% (v/v) benzyl benzoate (BB) and 40-55%% (v/v) of bisphenol-A ethoxylate diacrylate Mn 468 or 512;
preferably, the reagent for clearing tissue or organ further comprises N,N,N′,N′-Tetrakis(2-Hydroxypropyl)ethylenediamine (Quadrol) as decolorizing agent, preferably, 2-7% (v/v) Quadrol;
preferably, 2-hydroxy-4′-(2-hydroxyethoxy)-2-methylpropiophenone as UV initiator is further added, preferably, 1-3% (w/v) 2-Hydroxy-4′-(2-hydroxyethoxy)-2-methylpropiophenone is further added;
preferably, the reagent for clearing tissue or organ comprises 47% (v/v) benzyl benzoate, 48% (v/v) of bisphenol-A ethoxylate diacrylate having Mn of 468 or 512, 5% (v/v) Quadrol, and 2% w/v of 2-Hydroxy-4′-(2-hydroxyethoxy)-2-methylpropiophenone.

6-8. (canceled)

9. A reagent for dehydration of tissue or organ, comprising tert-butanol (tB) and N,N,N′,N′-Tetrakis(2-Hydroxypropyl) ethylenediamine (Quadrol),
preferably, the reagent for dehydration of tissue or organ comprises 60-80% (v/v) tB and 20-40% Quadrol (v/v), preferably, comprises 70% (v/v) tB and 30% (v/v) Quadrol;
preferably, the tissue or organ is any of tissue or organ of the animal, including but not limited to skin, hairy, muscle, bone, nerve, brain, paw, spinal-cord, vertebrae, mouse paw with skin, vertebrae with bone and muscles, spleen, liver, heart, eyeball, complete head of adult mouse, or even whole body of mouse pup.

10. (canceled)

11. A transparent embedding solvent system (TESOS), comprising the reagent for clearing tissue or organ in claim 1.

12. (canceled)

13. The transparent embedding solvent system (TESOS) of claim 11, further comprising the reagent for dehydration of tissue or organ which comprises tert-butanol (tB) and N,N,N′,N′-Tetrakis(2-Hydroxypropyl) ethylenediamine (Quadrol),
preferably, the reagent for dehydration of tissue or organ comprises 60-80% (v/v) tB and 20-40% Quadrol (v/v), preferably, comprises 70% (v/v) tB and 30% (v/v) Quadrol.

14. The transparent embedding solvent system (TESOS) of claim 11, further comprising a reagent for fixation, preferably, further comprising 4% PFA as the reagent for fixation; and/or
wherein the transparent embedding solvent system further comprises a reagent for decolorization, preferably, comprising 25% (w/v) N,N,N′,N′-Tetrakis(2-Hydroxypropyl)ethylenediamine (Quadrol) solution as the decolorizing reagent; and/or
wherein the transparent embedding solvent system further comprises a reagent for delipidation, preferably, comprising gradient tert-butanol (tB) solution for delipidation, preferably tert-Butanol (tB) is diluted with water to prepare gradient delipidation solutions: 30% (v/v), 50% (v/v) and 70% (v/v); and/or
wherein the transparent embedding solvent system further comprises a reagent for decalcification.

15-22. (canceled)

23. The transparent embedding solvent system (TESOS) of claim 11, wherein the reagents within the transparent embedding solvent system are contained in separated containers.

24. A method for clearing tissue or organ, comprising a step of clearing tissue or organ using the reagent for clearing tissue or organ in claim 1.

25. A method for transparent embedding, comprising a step of transparent embedding using the transparent embedding solvent system in claim 11.

26. The method for transparent embedding of claim 25, wherein the step of transparent embedding comprises a step of clearing tissue or organ, and a step of UV-initiated polymerization of the monomer crosslinker.

27. The method for transparent embedding of claim 25, further comprising a step of dehydration using the reagent for dehydration which comprises tert-butanol (tB) and N,N,N′,N′-Tetrakis(2-Hydroxypropyl) ethylenediamine (Quadrol), preferably, the reagent for dehydration of tissue or organ comprises 60-80% (v/v) tB and 20-40% Quadrol (v/v), preferably, comprises 70% (v/v) tB and 30% (v/v) Quadrol; and/or
the method further comprises a step of fixation using the reagent for fixation, preferably, the reagent for fixation comprises 4% PFA by weight in the solvent, more preferably, the reagent for fixation is 4% paraformaldehyde in 0.01M PBS; and/or
the method further comprises a step of decolorization using the reagent for decolorization, preferably, the reagent for decolorization comprises 25% N,N,N′,N′-Tetrakis(2-Hydroxypropyl)ethylenediamine (Quadrol) solution; and/or
the method further comprises a step of delipidation using the reagent for delipidation, preferably, the reagent for delipidation comprises gradient tert-butanol (tB) solution; and/or
the method further comprises a step of decalcification using the reagent for decalcification, preferably, the reagent for decalcification is EDTA solution, more preferably, the reagent for decalcification is composed of 20% (w/v) EDTA in water; and/or
the method comprises for a sample containing hard tissue, 4% PFA by weight fixation is performed at room temperature for 24 hrs and then the sample is decalcified in 20% EDTA (pH 7.0) for 4 days, the sample is next decolorized with the Quadrol decolorization solution for two days, the sample is then placed in gradient tB delipidation solutions for 1-2 days and then tB-Q for 2 days for dehydration, and finally, the sample is immersed in the BB-BED clearing medium for at least one day until transparency being achieved; and/or
the method comprises for a soft tissue or organ, 4% PFA fixation is performed at room temperature for 24 hrs, the sample is treated with Quadrol decolorization solution for 2 days, the sample is next treated with gradient delipidation solutions for 1 to 2 days, followed by tB delipidation solutions for 1-2 days, and, finally the sample is placed in the BB-BED clearing medium for at least one day until transparency being achieved.

28-33. (canceled)

34. The method for transparent embedding tissue or organ of claim 25, comprising the following steps: fixation, dehydration, clearing, and transparent embedding; and/or
the method comprises the following steps: fixation, decolorization, dehydration, clearing, and transparent embedding; and/or
the method comprises the following steps: fixation, decolorization, delipidation, dehydration clearing, and transparent embedding; and/or
the method comprises the following steps: fixation, decalcification, decolorization, delipidation, dehydration, clearing, and transparent embedding.

35-37. (canceled)

38. A method for microscopic imaging, comprising transparently embedding using the transparent embedding solvent system in claim 11.

39. The method for microscopic imaging of claim 38, further comprising a step of microscopic imaging using a microscope,
preferably, the microscope is a confocal microscope, a two photon microscope, or a light sheet microscope, comprising a kinematic base;
preferably, the kinematic base comprises a top plate and a bottom plate, preferably, the top plate is capable of being removed and replaced with an ON/OFF switch bar which interrupts the magnetic force coupling the plates of the base, and preferably the bottom plate is secured under an upright confocal microscope, a two photon microscope, or a light sheet microscope;
preferably, the bottom plate of the kinematic base is screwed onto a mounting base, and the mounting base is tightly clamped onto the specimen clamp of a lab microtome,
after imaging the selected sample area, the coverslip is removed by sliding it off the surface, the sample is transferred to the microtome for sectioning, the sectioning depth is at least 10% less than the Z-stack depth to provide overlapping area for stack stitching, and the sectioned sample is repositioned onto the kinematic base on the microscopy stage and dropped with BB-BED medium followed by coverslip placement and UV curing for the next imaging cycle.

40. The method for microscopic imaging of claim 38, further comprising a step of sectioning the transparently embedded sample; and/or
the method further comprises a step of alignment to ensure that the sectioning plane is parallel to the imaging plane; and/or
after sectioning, the surface is dropped with BB-BED medium and covered with a glass coverslip, and the sample is next cured with a UV lamp for three to seven, for example, five seconds to polymerize the newly added medium and to secure the coverslip; and/or
the method further comprises a step of immunofluorescent staining using an antibody against laminin and/or GFAP; and/or
the method further comprises a step of linear channel unmixing is to distinguish true fluorescent signal from tissue autofluorescence.

41-45. (canceled)

46. The method for microscopic imaging of claim 38, wherein the top plane of the Z stack is at least 10 μm below the sample sectioning surface to avoid distortion on the surface.

47. (canceled)

48. The method for microscopic imaging of claim 38, wherein the top surface of the sample is removed with a high-speed bur on the milling motor, which is built next to the microscope stand, and the sample is moved along a linear guide between the motor and the microscope.

49-51. (canceled)

52. A method for transparent embedding, comprising a step of clearing tissue or organ using the reagent for clearing tissue or organ in claim 1.
